(19) United States
(12) Patent Application Publication
(10) Pub. No.: US 2026/0111642 A1
(43) Pub. Date: Apr. 23, 2026

(54) TUNING COUPLING STRENGTH BETWEEN CONTROL LINES AND QUANTUM CIRCUIT DEVICES IN SUPERCONDUCTING QUANTUM PROCESSORS

(71) Applicant: Rigetti & Co, LLC, Berkeley, CA (US)

(72) Inventors: Alysson Rebecca Gold, Berkeley, CA (US); Brandon Wiliam Langley, Oakland, CA (US); Prasad Sarangapani, Fremont, CA (US); Benjamin Charles Scharmann, New York, NY (US); Andrew Joseph Bestwick, Berkeley, CA (US)

(73) Assignee: Rigetti & Co, LLC, Berkeley, CA (US)

(21) Appl. No.: 18/927,307

(22) Filed: Oct. 25, 2024

Related U.S. Application Data
(63) Continuation of application No. PCT/US2024/044800, filed on Aug. 30, 2024.
(60) Provisional application No. 63/580,249, filed on Sep. 1, 2023.

(51) Int. Cl. G06F 30/392; G06F 115/10; G06N 10/40

(52) U.S. Cl. CPC G06F 30/392; G06N 10/40; G06F 2115/10

(57) ABSTRACT

In a general aspect, tuning the coupling strength between a qubit device and nearby control lines is described. In some implementations, a method includes identifying a design of first and second quantum processor wafers of a quantum processing system. The first quantum processor wafer includes a qubit device which includes two qubit electrodes and a SQUID loop. The second quantum processor wafer includes a control line which is configured to apply control signals to the qubit device and includes first and second control ports, a circuit loop inductively coupled to the SQUID loop, and conductive traces connected between the circuit loop and the respective first and second control ports. The control lines are capacitively coupled to the two qubit electrodes. The method includes obtaining simulation data and experimental data from measurements of the quantum processing system, and modifying the design based on the simulation data and the experimental data.

### CROSS-REFERENCE TO RELATED APPLICATIONS

This application claims priority to U.S. Provisional Patent Application No. 63/580,249, filed Sep. 1, 2023, entitled “Tuning Coupling Strength between Control Lines and Quantum Circuit Devices in Superconducting Quantum Processors.” The above-referenced priority document is incorporated herein by reference.

### TECHNICAL FIELD

The following description relates to quantum circuit devices in superconducting quantum processors.

### BACKGROUND

Quantum computers can perform computational tasks by storing and processing information within quantum states of quantum systems. For example, qubits (i.e., quantum bits) can be stored in and represented by an effective two-level sub-manifold of a quantum coherent physical system. A variety of physical systems have been proposed for quantum computing applications. Examples include superconducting circuits, trapped ions, spin systems and others.

### BRIEF DESCRIPTION OF THE DRAWINGS

FIG. 1 is a block diagram of an example computing system.

FIG. 2A includes schematic diagrams of top view and cross-sectional view of an example superconducting quantum processing unit.

FIG. 2B is a schematic diagram of a top view of an example superconducting quantum processing unit.

FIG. 3 is a circuit diagram showing an example equivalent circuit of the example quantum processing unit in FIG. 2A.

FIG. 4 is a flow chart showing aspects of an example process for optimizing design parameters of a control line.

FIGS. 5A-5B are schematic diagrams showing a perspective view and a top view of an example quantum processing unit.

FIG. 6 is a plot showing dimensionless qubit device-control line coupling as a function of the arm rotation angle of the capacitive tuning element shown in FIGS. 5A-5B.

FIGS. 7A-7B are schematic diagrams showing perspective view and top view of an example quantum processing unit with a capacitive tuning element connected to a coupler control line.

FIG. 8 is a plot showing the coupling strength X_{qd} as a function of the stub length of the capacitive tuning element shown in FIGS. 7A-7B.

FIG. 9 is a plot showing the qubit loss rate in KHz as a function of the qubit frequency in GHz.

FIG. 10 is a flow chart showing aspects of an example measurement process to empirically determine the driveability (D) of a quantum circuit device through a control line in a quantum computing system.

FIG. 11A is a plot showing the qubit rotation of a qubit device in Bloch Sphere in radians as a function of voltage in volt applied on a control line associated to the qubit device.

FIG. 11B includes plots showing inferred excited state population and residuals of a qubit device as a function of decay time in microsecond (μs).

FIG. 12A is a plot showing distributions for the median measured values of the driveability as a function of the arm rotation angle of the capacitive tuning element connected to the control line shown in FIGS. 5A-5B.

FIG. 12B is a plot showing the decoherence rate (Γ₁), fD² and f³D² as a function of the tunable frequency range of a qubit device.

FIG. 12C is a plot showing median Γ1 (over five measurements) as a function of fD², for all qubit devices measured across their tunable frequency ranges.

FIGS. 13A-13B are schematic diagrams showing perspective view and top view of an example quantum processing unit.

### DETAILED DESCRIPTION

In some aspects of what is described here, a superconducting quantum processing unit of a quantum computing system includes two quantum processor wafers, e.g., a device wafer and a cap wafer, bonded together. In some instances, a cap wafer may include control lines; and a device wafer may include an array of superconducting quantum circuit devices (e.g., qubit devices and other types of devices) controlled by respective control lines on the cap wafer. In some instances, the two quantum processor wafers are spaced apart such that control lines and an associated superconducting quantum circuit device are capacitively coupled, inductively coupled, or coupled in another manner. The various control lines on the cap wafer can communicate control signals from control systems typically residing at an ambient temperature to the superconducting quantum circuit devices residing at a lowest-temperature thermal stage at a cryogenic temperature in a cryostat.

In some instances, the various control lines may include flux bias control lines, qubit drive lines (e.g., gate lines, microwave control lines directly drive the qubit, charge control lines, or XY control lines), combined flux bias and qubit drive lines, readout transmit signal lines, readout receive signal lines, and other types of control lines carrying control signals with different characteristics (e.g., in different frequency regimes, with different amplitudes, etc.). For example, a flux bias line associated with a qubit device can be used to tune the magnetic field in a superconducting circuit loop of the qubit device to tune its operating frequency; and a qubit drive line associated with a qubit device may be used to communicate a microwave qubit drive signal to manipulate its quantum state. In some instances, a combined flux bias and qubit drive line as a single control line, can be used to tune the operating frequency and manipulate the quantum state of the qubit device. For another example, a coupler flux bias line is configured to communicate a flux bias signal to a tunable coupler device to tune its operating frequency; a readout transmit line is configured to communicate a pulse signal to a resonator device coupled to the qubit device; and a readout receive line is configured to receive a resulting pulse from the resonator device. In certain instances, a quantum circuit device in a quantum processing unit may not only interact with one or more control lines that are associated with the quantum circuit device, but also may unfavorably interact with nearby control lines configured to communicate control signals to neighboring quantum circuit devices.

With the increasing size and complexity of quantum processing units, more control lines (e.g., qubit drive lines, flux bias lines, and readout lines) are required to manipulate and measure qubits, perform multi-qubit quantum logic gate operations, or other control operations. For example, a tunable coupler device can be configured between qubit devices to enable couplings between the qubit devices. Operations of the tunable coupler device require one or more control lines associated with the tunable coupler device. The device array in the quantum processing unit may have square or diamond lattices with four-fold connectivity. The on-chip routing of these control lines on the cap wafer, numbering in the hundreds, presents a monumental design challenge: one must ensure that the intentional coupling strength of these control lines to their targeted quantum circuit devices is strong enough to rapidly manipulate and measure the quantum states of qubit devices and coupler devices while ensuring that the coupling strength of unintentional couplings to nearby quantum circuit devices, are weak enough to maintain a high Purcell limit.

In some implementations, the systems and techniques described here can provide technical advantages and improvements. For example, the methods and techniques presented here can use simulation to determine design parameters of one or more control lines that sets respective coupling strength to a target quantum circuit device and one or more neighboring quantum circuit devices. For example, the methods and techniques presented here can tune the design parameters of a control line to achieve an optimal coupling strength balancing the tradeoff between quantum logic gate performance (e.g., fast gate times) with decoherence times (e.g., long decoherence times such that the quantum state is long-lived relative to the algorithm runtime) or energy losses. In certain instances, the methods and techniques presented here allow the tuning of design parameters of a control line so as to tune the coupling strength between the control line and a targeted quantum circuit device. A target quantum circuit device may be an associated quantum circuit device that is directly controlled by the control line or a neighboring quantum circuit device which may reside adjacent to the associated quantum circuit device on the device wafer. In some instances, the methods and techniques presented here can also tune design parameters of a control line so as to reduce the undesired coupling or minimize the parasitic coupling between the control line and a neighboring quantum circuit device. In some instances, the device wafer may include one or more capacitive tuning elements connected to the quantum circuit device; and the design parameters (e.g., locations, sizes, etc.) of the capacitive tuning element on the device wafer may be tuned to effectively tune the respective coupling strength between each of the control lines on the cap wafer and the associated quantum circuit device on the device wafer.

In some implementations, the methods and techniques presented here allow identification of an empirically measurable parameter which can be used to determine the relationship between the maximum achievable decoherence time on the quantum circuit device and the coupling strength (e.g., between the respective control line and the quantum circuit device). The determined relationship can be feedback to the simulation to guide the modification or refinement of the design parameters of the control lines to achieve optimal coupling strength according to one or more predefined constraints. For example, when the control lines reside on a cap wafer that is bonded to a device wafer where the quantum circuit device resides, the determined relationship can be used to modify the layout of superconducting circuitry on the cap wafer, including the location, the size, the number of segments, the direction, and other design parameters of the control lines on the cap wafer. In some cases, a combination of these and potentially other advantages and improvements may be obtained.

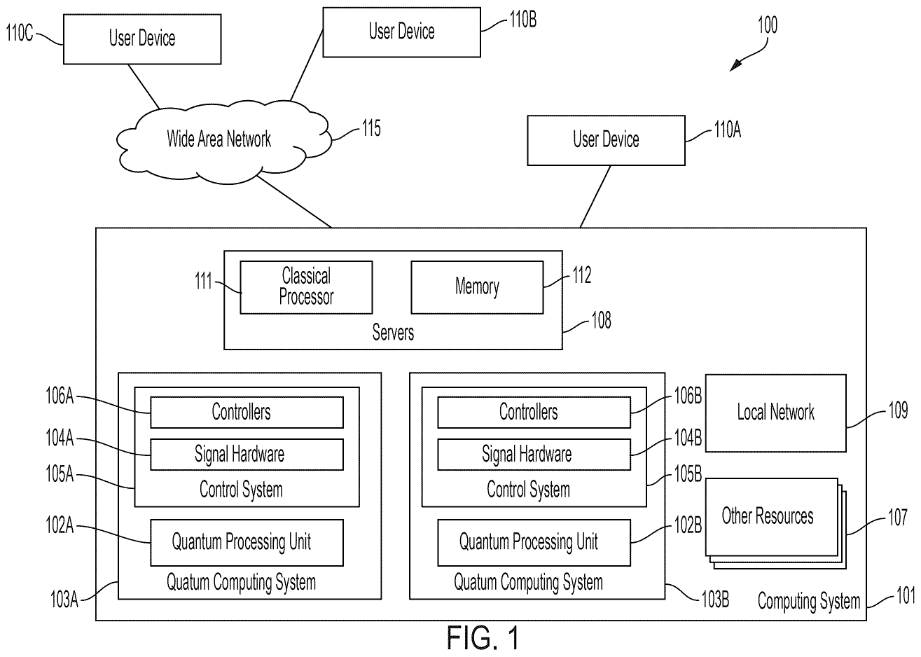

FIG. 1 is a block diagram of an example computing environment 100. The example computing environment 100 shown in FIG. 1 includes a computing system 101 and user devices 110A, 110B, 110C. A computing environment may include additional or different features, and the components of a computing environment may operate as described with respect to FIG. 1 or in another manner.

The example computing system 101 includes classical and quantum computing resources and exposes their functionality to the user devices 110A, 110B, 110C (referred to collectively as “user devices 110”). The computing system 101 shown in FIG. 1 includes one or more servers 108, quantum computing systems 103A, 103B, a local network 109 and other resources 107. The computing system 101 may also include one or more user devices (e.g., the user device 110A) as well as other features and components. A computing system may include additional or different features, and the components of a computing system may operate as described with respect to FIG. 1 or in another manner.

The example computing system 101 can provide services to the user devices 110, for example, as a cloud-based or remote-accessed computer system, as a distributed computing resource, as a supercomputer or another type of high-performance computing resource, or in another manner. The computing system 101 or the user devices 110 may also have access to one or more other quantum computing systems (e.g., quantum computing resources that are accessible through the wide area network 115, the local network 109 or otherwise).

The user devices 110 shown in FIG. 1 may include one or more classical processor, memory, user interfaces, communication interfaces, and other components. For instance, the user devices 110 may be implemented as laptop computers, desktop computers, smartphones, tablets or other types of computer devices. In the example shown in FIG. 1, to access computing resources of the computing system 101, the user devices 110 send information (e.g., programs, instructions, commands, requests, input data, etc.) to the servers 108; and in response, the user devices 110 receive information (e.g., application data, output data, prompts, alerts, notifications, results, etc.) from the servers 108. The user devices 110 may access services of the computing system 101 in another manner, and the computing system 101 may expose computing resources in another manner.

In the example shown in FIG. 1, the local user device 110A operates in a local environment with the servers 108 and other elements of the computing system 101. For instance, the user device 110A may be co-located with (e.g., located within 0.5 to 1 km of) the servers 108 and possibly other elements of the computing system 101. As shown in FIG. 1, the user device 110A communicates with the servers 108 through a local data connection.

The local data connection in FIG. 1 is provided by the local network 109. For example, some or all of the servers 108, the user device 110A, the quantum computing systems 103A, 103B and the other resources 107 may communicate with each other through the local network 109. In some implementations, the local network 109 operates as a communication channel that provides one or more low-latency communication pathways from the server 108 to the quantum computer systems 103A, 103B (or to one or more of the elements of the quantum computer systems 103A, 103B). The local network 109 can be implemented, for instance, as a wired or wireless Local Area Network, an Ethernet connection, or another type of wired or wireless connection. The local network 109 may include one or more wired or wireless routers, wireless access points (WAPs), wireless mesh nodes, switches, high-speed cables, or a combination of these and other types of local network hardware elements. In some cases, the local network 109 includes a software-defined network that provides communication among virtual resources, for example, among an array of virtual machines operating on the server 108 and possibly elsewhere.

In the example shown in FIG. 1, the remote user devices 110B, 110C operate remotely from the servers 108 and other elements of the computing system 101. For instance, the user devices 110B, 110C may be located at a remote distance (e.g., more than 1 km, 10 km, 100 km, 1,000 km, 10,000 km, or farther) from the servers 108 and possibly other elements of the computing system 101. As shown in FIG. 1, each of the user devices 110B, 110C communicates with the servers 108 through a remote data connection.

The remote data connection in FIG. 1 is provided by a wide area network 115, which may include, for example, the Internet or another type of wide area communication network. In some cases, remote user devices use another type of remote data connection (e.g., satellite-based connections, a cellular network, a virtual private network, etc.) to access the servers 108. The wide area network 115 may include one or more internet servers, firewalls, service hubs, base stations, or a combination of these and other types of remote networking elements. Generally, the computing environment 100 can be accessible to any number of remote user devices.

The example servers 108 shown in FIG. 1 can manage interaction with the user devices 110 and utilization of the quantum and classical computing resources in the computing system 101. For example, based on information from the user devices 110, the servers 108 may delegate computational tasks to the quantum computing systems 103A, 103B and the other resources 107; the servers 108 can then send information to the user devices 110 based on output data from the computational tasks performed by the quantum computing systems 103A, 103B and the other resources 107.

As shown in FIG. 1, the servers 108 are classical computing resources that include classical processors 111 and memory 112. The servers 108 may also include one or more communication interfaces that allow the servers to communicate via the local network 109, the wide area network 115 and possibly other channels. In some implementations, the servers 108 may include a host server, an application server, a virtual server or a combination of these and other types of servers. The servers 108 may include additional or different features; and may operate as described with respect to FIG. 1 or in another manner.

The classical processors 111 can include various kinds of apparatus, devices, and machines for processing data, including, by way of example, a microprocessor, a central processing unit (CPU), a graphics processing unit (GPU), an FPGA (field programmable gate array), an ASIC (application specific integrated circuit), or combinations of these. The memory 112 can include, for example, a random-access memory (RAM), a storage device (e.g., a writable read-only memory (ROM) or others), a hard disk, or another type of storage medium. The memory 112 can include various forms of volatile or non-volatile memory, media and memory devices, etc.

Each of the example quantum computing systems 103A, 103B operates as a quantum computing resource in the computing system 101. The other resources 107 may include additional quantum computing resources (e.g., quantum computing systems, quantum simulators, or both) as well as classical (non-quantum) computing resources such as, for example, digital microprocessors, specialized co-processor units (e.g., graphics processing units (GPUs), cryptographic co-processors, etc.), special purpose logic circuitry (e.g., field programmable gate arrays (FPGAs), application-specific integrated circuits (ASICs), etc.), systems-on-chips (SoCs), etc., or combinations of these and other types of computing modules.

In some implementations, the servers 108 generate programs, identify appropriate computing resources (e.g., a QPU or QVM) in the computing system 101 to execute the programs, and send the programs to the identified resources for execution. For example, the servers 108 may send programs to the quantum computing system 103A, the quantum computing system 103B or any of the other resources 107. The programs may include classical programs, quantum programs, hybrid classical/quantum programs, and may include any type of function, code, data, instruction set, etc.

In some instances, programs can be formatted as source code that can be rendered in human-readable form (e.g., as text) and can be compiled, for example, by a compiler running on the servers 108, on the quantum computing systems 103, or elsewhere. In some instances, programs can be formatted as compiled code, such as, for example, binary code (e.g., machine-level instructions) that can be executed directly by a computing resource. Each program may include instructions corresponding to computational tasks that, when performed by an appropriate computing resource, generate output data based on input data. For example, a program can include instructions formatted for a quantum computer system, a simulator, a digital microprocessor, co-processor or other classical data processing apparatus, or another type of computing resource.

In some cases, a program may be expressed in a hardware-independent format. For example, quantum machine instructions may be provided in a quantum instruction language such as Quil, described in the publication “A Practical Quantum Instruction Set Architecture,” arXiv: 1608.03355v2, dated Feb. 17, 2017, or another quantum instruction language. For instance, the quantum machine instructions may be written in a format that can be executed by a broad range of quantum processing units or simulators. In some cases, a program may be expressed in high-level terms of quantum logic gates or quantum algorithms, in lower-level terms of fundamental qubit rotations and controlled rotations, or in another form. In some cases, a program may be expressed in terms of control signals (e.g., pulse sequences, delays, etc.) and parameters for the control signals (e.g., frequencies, phases, durations, channels, etc.). In some cases, a program may utilize Quil-T, described in the publication “Gain deeper control of Rigetti quantum processors with Quil-T,” available at https://medium.com/rigetti/gain-deeper-control-of-rigetti-quantum-processors-with-quil-t-ea8943061e5b dated Dec. 10, 2020. In some cases, a program may be expressed in another form or format.

In some implementations, the servers 108 include one or more compilers that convert programs between formats. For example, the servers 108 may include a compiler that converts hardware-independent instructions to binary programs for execution by the quantum computing systems 103A, 103B. In some cases, a compiler can compile a program to a format that targets a specific quantum resource in the computer system 101. For example, a compiler may generate a different binary program (e.g., from the same source code) depending on whether the program is to be executed by the quantum computing system 103A or the quantum computing system 103B.

In some cases, a compiler generates a partial binary program that can be updated, for example, based on specific parameters. For instance, if a quantum program is to be executed iteratively on a quantum computing system with varying parameters on each iteration, the compiler may generate the binary program in a format that can be updated with specific parameter values at runtime (e.g., based on feedback from a prior iteration, or otherwise); the parametric update can be performed without further compilation. In some cases, a compiler generates a full binary program that does not need to be updated or otherwise modified for execution.

In some implementations, the servers 108 generate a schedule for executing programs, allocate computing resources in the computing system 101 according to the schedule, and delegate the programs to the allocated computing resources. The servers 108 can receive, from each computing resource, output data from the execution of each program. Based on the output data, the servers 108 may generate additional programs that are then added to the schedule, output data that is provided back to a user device 110, or perform another type of action.

In some implementations, all or part of the computing environment operates as a cloud-based quantum computing (QC) environment, and the servers 108 operate as a host system for the cloud-based QC environment. The cloud-based QC environment may include software elements that operate on both the user devices 110 and the computer system 101 and interact with each other over the wide area network 115. For example, the cloud-based QC environment may provide a remote user interface, for example, through a browser or another type of application on the user devices 110. The remote user interface may include, for example, a graphical user interface or another type of user interface that obtains input provided by a user of the cloud-based QC environment. In some cases, the remote user interface includes, or has access to, one or more application programming interfaces (APIs), command line interfaces, graphical user interfaces, or other elements that expose the services of the computer system 101 to the user devices 110.

In some cases, the cloud-based QC environment may be deployed in a “serverless” computing architecture. For instance, the cloud-based QC environment may provide on-demand access to a shared pool of configurable computing resources (e.g., networks, servers, storage, applications, services, quantum computing resources, classical computing resources, etc.) that can be provisioned for requests from user devices 110. Moreover, the cloud-based computing systems 101 may include or utilize other types of computing resources, such as, for example, edge computing, fog computing, etc.

In an example implementation of a cloud-based QC environment, the servers 108 may operate as a cloud provider that dynamically manages the allocation and provisioning of physical computing resources (e.g., GPUs, CPUs, QPUs, etc.). Accordingly, the servers 108 may provide services by defining virtualized resources for each user account. For instance, the virtualized resources may be formatted as virtual machine images, virtual machines, containers, or virtualized resources that can be provisioned for a user account and configured by a user. In some cases, the servers 108 include a container management and execution system that is implemented, for example, using KUBERNETES® or another software platform for container management. In some cases, the cloud-based QC environment is implemented, for example, using OPENSTACK® or another software platform for cloud-based computing that provides virtual servers or other virtual computing resources for users.

In some cases, the server 108 stores quantum machine images (QMI) for each user account. A quantum machine image may operate as a virtual computing resource for users of the cloud-based QC environment. For example, a QMI can provide a virtualized development and execution environment to develop and run programs (e.g., quantum programs or hybrid classical/quantum programs). When a QMI operates on the server 108, the QMI may engage either of the quantum processor units 102A, 102B, and interact with a remote user device (110B or 110C) to provide a user programming environment. The QMI may operate in close physical proximity to and have a low-latency communication link with the quantum computing systems 103A, 103B. In some implementations, remote user devices connect with QMIs operating on the servers 108 through secure shell (SSH) or other protocols over the wide area network 115.

In some implementations, all or part of the computing system 101 operates as a hybrid computing environment. For example, quantum programs can be formatted as hybrid classical/quantum programs that include instructions for execution by one or more quantum computing resources and instructions for execution by one or more classical resources. The servers 108 can allocate quantum and classical computing resources in the hybrid computing environment, and delegate programs to the allocated computing resources for execution. The quantum computing resources in the hybrid environment may include, for example, one or more quantum processing units (QPUs), one or more quantum simulators, or possibly other types of quantum resources. The classical computing resources in the hybrid environment may include, for example, one or more digital microprocessors, one or more specialized co-processor units (e.g., graphics processing units (GPUs), cryptographic co-processors, etc.), special purpose logic circuitry (e.g., field programmable gate arrays (FPGAs), application-specific integrated circuits (ASICs), etc.), systems-on-chips (SoCs), or other types of computing modules.

In some cases, the servers 108 can select the type of computing resource (e.g., quantum or classical) to execute an individual program, or part of a program, in the computing system 101. For example, the servers 108 may select a particular quantum processing unit (QPU) or other computing resource based on availability of the resource, speed of the resource, information or state capacity of the resource, a performance metric (e.g., process fidelity) of the resource, or based on a combination of these and other factors. In some cases, the servers 108 can perform load balancing, resource testing and calibration, and other types of operations to improve or optimize computing performance.

Each of the example quantum computing systems 103A, 103B shown in FIG. 1 can perform quantum computational tasks by executing quantum machine instructions (e.g., a binary program compiled for the quantum computing system). In some implementations, a quantum computing system can perform quantum computation by storing and manipulating information within quantum states of a composite quantum system. For example, qubits (i.e., quantum bits) can be stored in and represented by an effective two-level sub-manifold of a quantum coherent physical system. In some instances, quantum logic can be executed in a manner that allows large-scale entanglement within the quantum system. Control signals can manipulate the quantum states of individual qubits and the joint states of multiple qubits. In some instances, information can be read out from the composite quantum system by measuring the quantum states of the qubits. In some implementations, the quantum states of the qubits are read out by measuring the transmitted or reflected signal from auxiliary quantum devices that are coupled to individual qubits.

In some implementations, a quantum computing system can operate using gate-based models for quantum computing. For example, the qubits can be initialized in an initial state, and a quantum logic circuit comprised of a series of quantum logic gates can be applied to transform the qubits and extract measurements representing the output of the quantum computation. Individual qubits may be controlled by single-qubit quantum logic gates, and pairs of qubits may be controlled by two-qubit quantum logic gates (e.g., entangling gates that are capable of generating entanglement between the pair of qubits). In some implementations, a quantum computing system can operate using adiabatic or annealing models for quantum computing. For instance, the qubits can be initialized in an initial state, and the controlling Hamiltonian can be transformed adiabatically by adjusting control parameters to another state that can be measured to obtain an output of the quantum computation.

In some models, fault-tolerance can be achieved by applying a set of high-fidelity control and measurement operations to the qubits. For example, quantum error correcting schemes can be deployed to achieve fault-tolerant quantum computation. Other computational regimes may be used; for example, quantum computing systems may operate in non-fault-tolerant regimes. In some implementations, a quantum computing system is constructed and operated according to a scalable quantum computing architecture. For example, in some cases, the architecture can be scaled to a large number of qubits to achieve large-scale general purpose coherent quantum computing. Other architectures may be used; for example, quantum computing systems may operate in small-scale or non-scalable architectures.

The example quantum computing system 103A shown in FIG. 1 includes a quantum processing unit 102A and a control system 105A, which controls the operation of the quantum processing unit 102A. Similarly, the example quantum computing system 103B includes a quantum processing unit 102B and a control system 105B, which controls the operation of a quantum processing unit 102B. A quantum computing system may include additional or different features, and the components of a quantum computing system may operate as described with respect to FIG. 1 or in another manner.

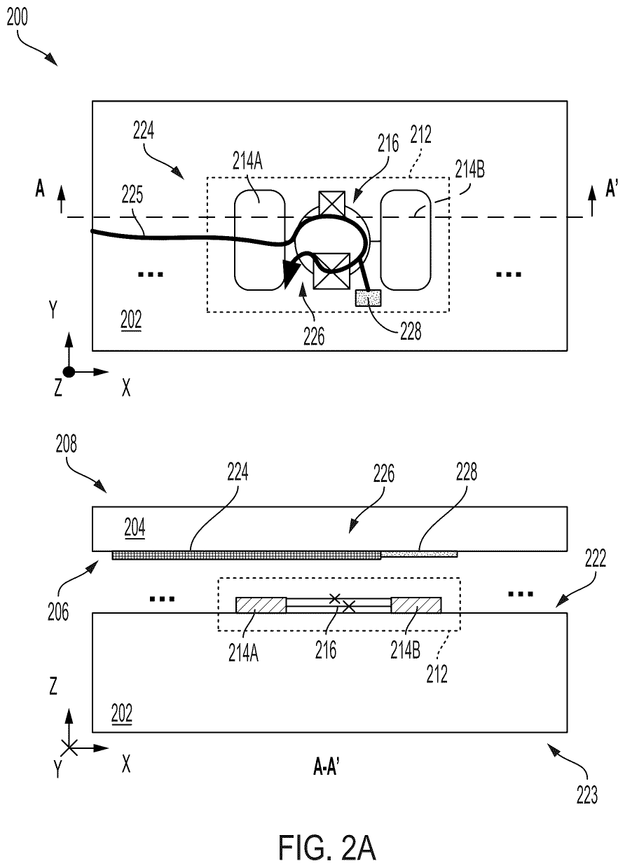

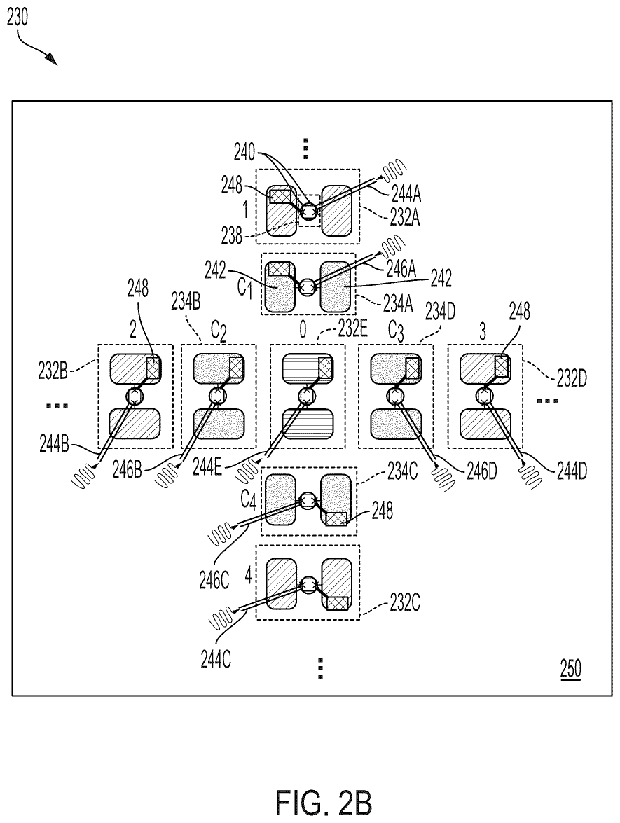

In some instances, all or part of the quantum processing unit 102A functions as a quantum processor, a quantum memory, or another type of subsystem. In some examples, the quantum processing unit 102A includes a quantum circuit system. The quantum circuit system may include qubit devices, readout devices and possibly other devices that are used to store and process quantum information. In some cases, the quantum processing unit 102A includes a first quantum processor wafer (e.g., the device wafer 202, 502, 702, 1302 in FIGS. 2, 5A-5B, 7A-7B, 13A-13B) which includes superconducting circuitry, and the qubit devices are implemented as circuit devices that include Josephson junctions, for example, in superconducting quantum interference device (SQUID) loops or other arrangements, and are controlled by radio-frequency signals, microwave signals, and bias signals delivered to the quantum processing unit 102A. In some cases, the quantum processing unit 102A includes an ion trap system, and the qubit devices are implemented as trapped ions controlled by optical signals delivered to the quantum processing unit 102A. In some cases, the quantum processing unit 102A includes a spin system, and the qubit devices are implemented as nuclear or electron spins controlled by microwave or radio-frequency signals delivered to the quantum processing unit 102A. The quantum processing unit 102A may be implemented based on another physical modality of quantum computing.

In some examples, qubit devices in the quantum processing unit 102A may include a tunable-frequency qubit device with a tunable transition frequency or a fixed-frequency qubit device with a fixed transition frequency. In some examples, qubit devices can be a floating qubit device with two respective qubit electrodes electrically floating at a certain potential without being conductively connected to a ground plane. In some instances, coupler devices in the quantum processing unit 102A may include a tunable floating coupler device with a tunable transition frequency and two respective coupler electrodes electrically floating at a certain potential, without being conductively connected to the ground plane. In some instances, qubit devices may include a grounded qubit device with one qubit electrode. In this case, the qubit device is considered as a grounded qubit device when a qubit device is connected between the qubit electrode and a ground plane. In certain instances, the coupler device may include a grounded coupler device connected between a coupler electrode and the ground plane.

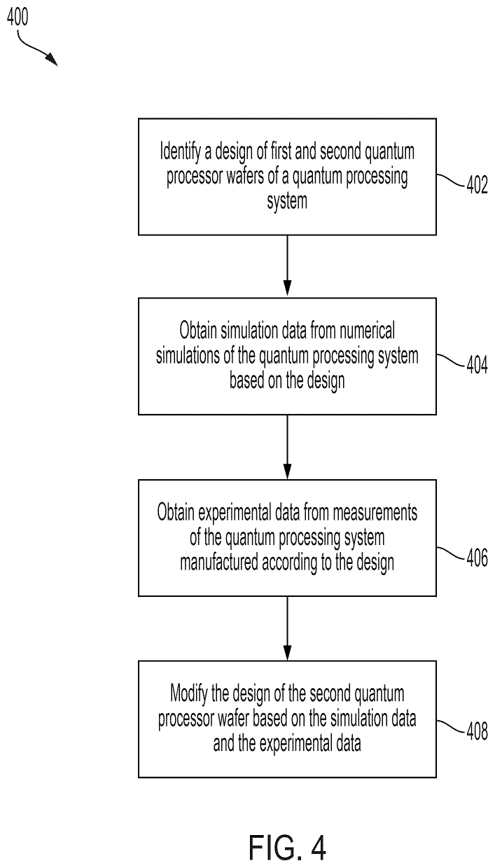

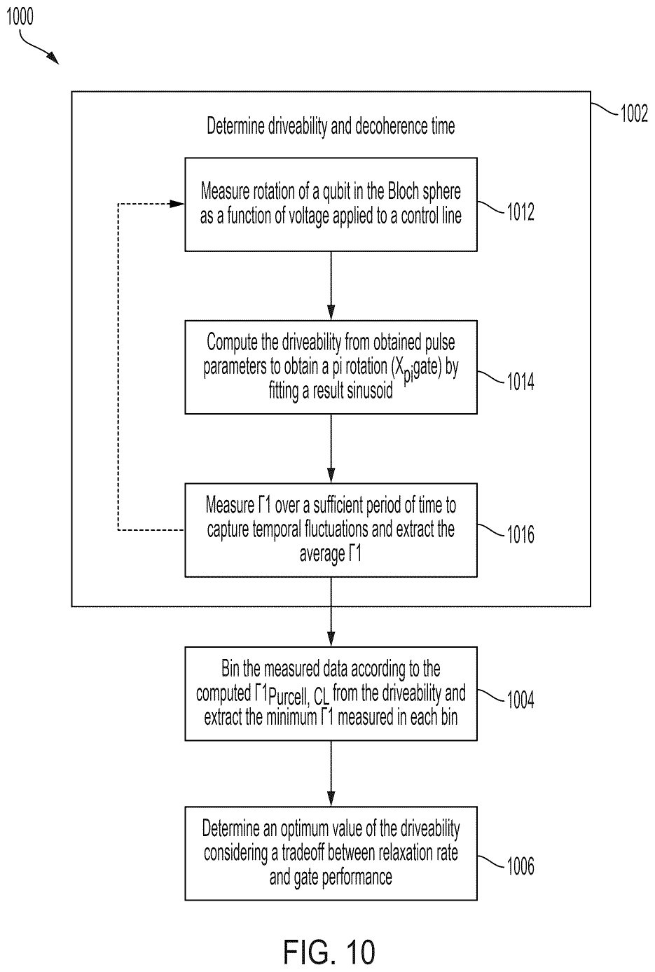

In certain instances, the quantum processing unit 102A includes a second quantum processor wafer (e.g., the cap wafer 204, 504, 704, 1304 in FIGS. 2, 5A-5B, 7A-7B, 13A-13B) which includes a control line that can be inductively coupled to a superconducting circuit loop (e.g., a SQUID loop) associated with a quantum circuit device (e.g., a qubit device or a coupler device) on the first quantum processor wafer; and the same control line may be capacitively coupled to the quantum circuit device via the capacitance formed between the control line and each of respective electrodes of the quantum circuit device (e.g., qubit electrodes of a qubit device or coupler electrodes of a coupler device). In some implementations, when a quantum circuit device is a “floating” quantum circuit device including two “floating” qubit electrodes which are not conductively connected to the ground plane. The control line can be designed, and design parameters of the control line can be modified by asymmetrically modifying the differential capacitance of the control line to the floating electrodes based on one or more predefined constraints. The predefined constraints may include minimizing the gate time, maximizing the coherence time, minimizing the energy loss, tuning the coupling strength, minimizing parasitic coupling to neighboring qubit devices, or other constraints. In some instances, a floating quantum circuit device may have multiple associated control lines (e.g., a flux bias line, a qubit drive line, a readout line, etc.); and each of the multiple control lines may be designed based on the predefined constraints by performing one or more operations of the example process 400, 1000 in FIGS. 4, 10 or in another manner.

The quantum processing unit 102A may include, or may be deployed within, a controlled environment. The controlled environment can be provided, for example, by shielding equipment, cryogenic equipment, and other types of environmental control systems. In some examples, the components in the quantum processing unit 102A operate in a cryogenic temperature regime and are subject to very low electromagnetic and thermal noise. For example, magnetic shielding can be used to shield the system components from stray magnetic fields, optical shielding can be used to shield the system components from optical noise, thermal shielding and cryogenic equipment can be used to maintain the system components at controlled temperature, etc.

In some implementations, the example quantum processing unit 102A can process quantum information by applying control signals to the qubits in the quantum processing unit 102A. The control signals can be configured to encode information in the qubits, to process the information by performing quantum logic gates or other types of operations, or to extract information from the qubits. In some examples, the operations can be expressed as single-qubit quantum logic gates, two-qubit quantum logic gates, or other types of quantum logic gates that operate on one or more qubits. A quantum logic circuit, which includes a sequence of quantum logic operations, can be applied to the qubits to perform a quantum algorithm. The quantum algorithm may correspond to a computational task, a hardware test, a quantum error correction procedure, a quantum state distillation procedure, or a combination of these and other types of operations.

The example control system 105A includes controllers 106A and signal hardware 104A. Similarly, control system 105B includes controllers 106B and signal hardware 104B. All or part of the control systems 105A, 105B can operate in a room-temperature environment or another type of environment, which may be located near the respective quantum processing units 102A, 102B. In some cases, the control systems 105A, 105B include classical computers, signaling equipment (microwave, radio, optical, bias, etc.), electronic systems, vacuum control systems, refrigerant control systems or other types of control systems that support operation of the quantum processing units 102A, 102B.

The control systems 105A, 105B may be implemented as distinct systems that operate independent of each other. In some cases, the control systems 105A, 105B may include one or more shared elements; for example, the control systems 105A, 105B may operate as a single control system that operates both quantum processing units 102A, 102B. Moreover, a single quantum computer system may include multiple quantum processing units, which may operate in the same controlled (e.g., cryogenic) environment or in separate environments.

The example signal hardware 104A includes components that communicate with the quantum processing unit 102A. The signal hardware 104A may include, for example, waveform generators, amplifiers, digitizers, high-frequency sources, DC sources, AC sources, etc. The signal hardware may include additional or different features and components. In the example shown, components of the signal hardware 104A are adapted to interact with the quantum processing unit 102A. For example, the signal hardware 104A can be configured to operate in a particular frequency range, configured to generate and process signals in a particular format, or the hardware may be adapted in another manner.

In some instances, one or more components of the signal hardware 104A generate control signals, for example, based on control information from the controllers 106A. The control signals can be delivered to the quantum processing unit 102A during operation of the quantum computing system 103A. For instance, the signal hardware 104A may generate signals to implement quantum logic operations, readout operations or other types of operations. As an example, the signal hardware 104A may include arbitrary waveform generators (AWGs) that generate electromagnetic waveforms (e.g., microwave or radio-frequency) or laser systems that generate optical waveforms. The waveforms or other types of signals generated by the signal hardware 104A can be delivered to devices in the quantum processing unit 102A to operate qubit devices, readout devices, bias devices, coupler devices or other types of components in the quantum processing unit 102A.

In some instances, the signal hardware 104A receives and processes signals from the quantum processing unit 102A. The received signals can be generated by the execution of a quantum program on the quantum computing system 103A. For instance, the signal hardware 104A may receive signals from the devices in the quantum processing unit 102A in response to readout or other operations performed by the quantum processing unit 102A. Signals received from the quantum processing unit 102A can be mixed, digitized, filtered, or otherwise processed by the signal hardware 104A to extract information, and the information extracted can be provided to the controllers 106A or handled in another manner. In some examples, the signal hardware 104A may include a digitizer that digitizes electromagnetic waveforms (e.g., microwave or radio-frequency) or optical signals, and a digitized waveform can be delivered to the controllers 106A or to other signal hardware components. In some instances, the controllers 106A process the information from the signal hardware 104A and provide feedback to the signal hardware 104A; based on the feedback, the signal hardware 104A can in turn generate new control signals that are delivered to the quantum processing unit 102A.

In some implementations, the signal hardware 104A includes signal delivery hardware that interfaces with the quantum processing unit 102A. For example, the signal hardware 104A may include filters, attenuators, directional couplers, multiplexers, diplexers, bias components, signal channels, isolators, amplifiers, power dividers and other types of components. In some instances, the signal delivery hardware performs preprocessing, signal conditioning, or other operations to the control signals to be delivered to the quantum processing unit 102A. In some instances, signal delivery hardware performs preprocessing, signal conditioning or other operations on readout signals received from the quantum processing unit 102A.

The example controllers 106A communicate with the signal hardware 104A to control operations of the quantum computing system 103A. The controllers 106A may include classical computing hardware that directly interfaces with components of the signal hardware 104A. The example controllers 106A may include classical processors, memory, clocks, digital circuitry, analog circuitry, and other types of systems or subsystems. The classical processors may include one or more single- or multi-core microprocessors, digital electronic controllers, special purpose logic circuitry, e.g., an FPGA (field programmable gate array) or an ASIC (application specific integrated circuit), or other types of data processing apparatus. The memory may include any type of volatile or non-volatile memory or another type of computer storage medium. The controllers 106A may also include one or more communication interfaces that allow the controllers 106A to communicate via the local network 109 and possibly other channels. The controllers 106A may include additional or different features and components.

In some implementations, the controllers 106A include memory or other components that store quantum state information, for example, based on qubit readout operations performed by the quantum computing system 103A. For instance, the states of one or more qubits in the quantum processing unit 102A can be measured by qubit readout operations, and the measured state information can be stored in a cache or other type of memory system in or more of the controllers 106A. In some cases, the measured state information is subsequently used in the execution of a quantum program, a quantum error correction procedure, a quantum processing unit (QPU) calibration or testing procedure, or another type of quantum process.

In some implementations, the controllers 106A include memory or other components that store a quantum program containing quantum machine instructions for execution by the quantum computing system 103A. In some instances, the controllers 106A can interpret the quantum machine instructions and perform hardware-specific control operations according to the quantum machine instructions. For example, the controllers 106A may cause the signal hardware 104A to generate control signals that are delivered to the quantum processing unit 102A to execute the quantum machine instructions.

In some instances, the controllers 106A extract qubit state information from qubit readout signals, for example, to identify the quantum states of qubits in the quantum processing unit 102A or for other purposes. For example, the controllers may receive the qubit readout signals (e.g., in the form of analog waveforms) from the signal hardware 104A, digitize the qubit readout signals, and extract qubit state information from the digitized signals. In some cases, the controllers 106A compute measurement statistics based on qubit state information from multiple shots of a quantum program. For example, each shot may produce a bitstring representing qubit state measurements for a single execution of the quantum program, and a collection of bitsrings from multiple shots may be analyzed to compute quantum state probabilities.

In some implementations, the controllers 106A include one or more clocks that control the timing of operations. For example, operations performed by the controllers 106A may be scheduled for execution over a series of clock cycles, and clock signals from one or more clocks can be used to control the relative timing of each operation or groups of operations. In some implementations, the controllers 106A may include classical computer resources that perform some or all of the operations of the servers 108 described above. For example, the controllers 106A may operate a compiler to generate binary programs (e.g., full or partial binary programs) from source code; the controllers 106A may include an optimizer that performs classical computational tasks of a hybrid classical/quantum program; the controllers 106A may update binary programs (e.g., at runtime) to include new parameters based on an output of the optimizer, etc.

The other quantum computer system 103B and its components (e.g., the quantum processing unit 102B, the signal hardware 104B and controllers 106B) can be implemented as described above with respect to the quantum computer system 103A; in some cases, the quantum computer system 103B and its components may be implemented or may operate in another manner.

In some implementations, the quantum computer systems 103A, 103B are disparate systems that provide distinct modalities of quantum computation. For example, the computer system 101 may include both an adiabatic quantum computer system and a gate-based quantum computer system. As another example, the computer system 101 may include a superconducting circuit-based quantum computer system and an ion trap-based quantum computer system. In such cases, the computer system 101 may utilize each quantum computing system according to the type of quantum program that is being executed, according to availability or capacity, or based on other considerations.

The native quantum program includes a sequence of native quantum logic gates, e.g., single-qubit native quantum logic gates, two-qubit native quantum logic gates, multi-qubit native quantum logic gates, multi-level native quantum logic gates (e.g., qutrit or other qudits), and other types of quantum logic gates to execute the quantum program. To simplify description, a qubit, as referred to herein, may refer to a two-level qubit or any other higher-level system such as qutrits or any other qudit.

FIG. 2A includes schematic diagrams of top view and cross-sectional view of an example quantum processing unit 200. The example quantum processing unit 200 is a superconducting quantum processing unit which includes two quantum processor wafers, e.g., a device wafer 202 and a cap wafer 204. As shown in FIG. 2A, the cap wafer 204 includes a first surface 206 and a second surface 208; and the device wafer 202 includes a first surface 222 and a second surface 223. The first surface 206 of the cap wafer 204 and the first surface 222 of the device wafer 202 face each other and are bonded together, for example spaced apart through bonding bumps. The device wafer 202 includes a quantum circuit device 212 residing on the first surface 222. The cap wafer 204 includes a control line 224 associated with the quantum circuit device 212 and configured to communicate control signals to the quantum circuit device 212. In some instances, the control line 224 on the cap wafer 204 may inductively and/or capacitively interact with the quantum circuit device 212 on the device wafer 202.

In some implementations, the example quantum processing unit 200 may include additional and different features or components; and components of the example quantum processing unit 200 may be implemented in another manner. For example, the features and components represented in FIG. 2A can be extended in a larger two-dimensional or three-dimensional array of devices. For another example, the example quantum processing unit 200 may include respective readout resonator devices associated with the quantum circuit device 212 for performing readout operations; and bonding bumps, through-hole conductive via, and multiple control lines (e.g., flux bias control lines and/or XY qubit control lines) for communicating control signals from a control system (e.g., the signal hardware 104A, 104B of the control system 105A, 105B) to the associated quantum circuit devices to perform quantum logic operations. For another example, the example quantum processing unit 200 may include one device wafer and multiple cap wafers, one cap wafer with multiple device wafers, or multiple device and multiple cap wafers.

As shown in FIGS. 2A-2B, the control lines 224 includes a circuit loop 226, conductive traces 225 galvanically connected to the circuit loop 226, and a capacitive tuning element 228. In some instances, the control lines 224 further includes two control ports which may extend from the first surface 206 to the second surface 208 of the cap wafer 204. In some instances, one of the two control ports of the control line 224 (as indicated by the arrow at one end of the control line 226) may be galvanically connected to ground on the cap wafer 204. In some instances, the device wafer 202 and the cap wafer 204 include ground planes on the first surface 222 of the device wafer 202 and the first surface 206 of the cap wafer 204; and the ground planes on the device wafer 202 and the cap wafer 204 may be bonded together, for example, by the bonding bumps.

In some implementations, the quantum circuit device 212 disposed on the first surface 222 of the device wafer 202 may be a tunable-frequency qubit device, a tunable-frequency coupler device, or another type of superconducting quantum circuit device. As shown in FIG. 2A, the quantum circuit device 212 is configured as a tunable transmon qubit device with a pair of qubit electrodes 214A, 214B and two Josephson junctions forming a SQUID loop 216. The pair of qubit electrodes 214A, 214B are configured to form a shunt capacitor in parallel with the SQUID loop 216. In some instances, the qubit electrodes 214A, 214B of the quantum circuit device 212 may be configured to capacitively couple to other circuit components in the cap wafer 204 or the device wafer 202, for example, the conductive traces 225, the circuit loop 226, and the capacitive tuning element 228 of the control line 224 on the cap wafer 204. The qubit electrodes 214A, 214B include superconducting materials which may be surrounded by the ground planes on the first surface 222 of the device wafer 202. As shown in FIG. 2A, the qubit electrodes 214A, 214B are electrically floating at a certain potential without being galvanically connected to the ground plane. In other words, since the ground plane is configured around superconducting quantum circuit device 212, the qubit electrodes 214A, 214B are capacitively coupled to the ground plane. In some instances, the quantum circuit device 212 may include additional or different features; and may operate as described with respect to FIG. 2A or in another manner. For example, the superconducting circuit loop 216 may include more than two Josephson junctions.

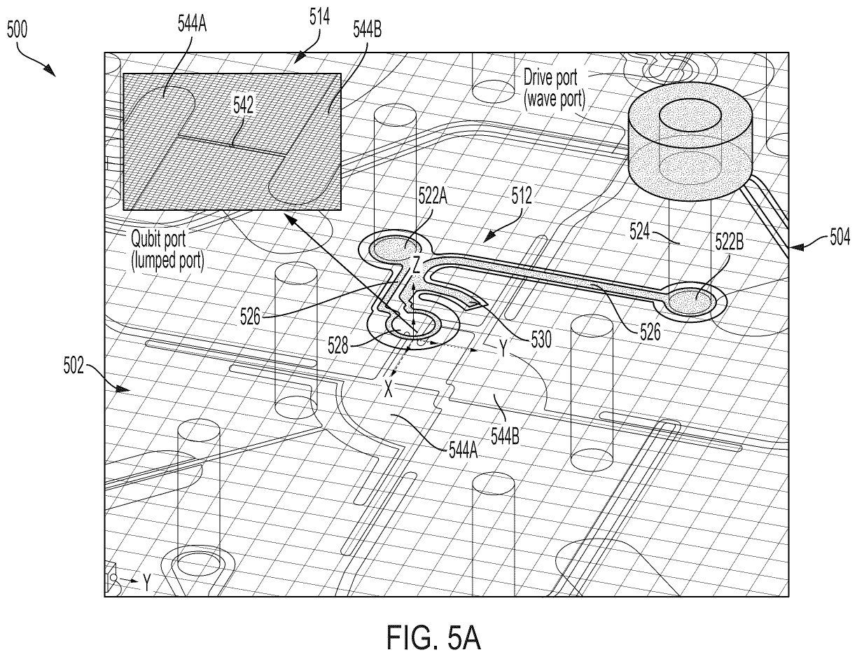

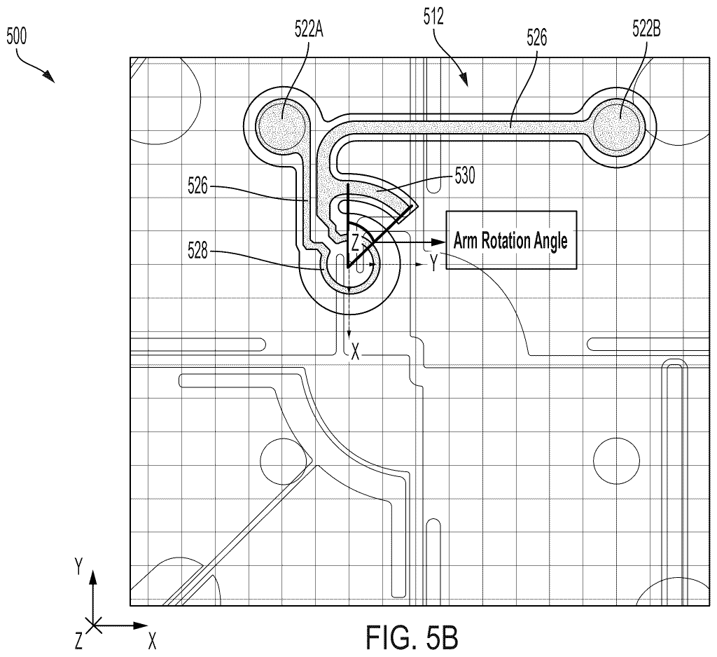

In some implementations, the control line 224 on the first surface 206 of the cap wafer 204 are made of superconductive material or other conductive material that carries a control signal to and from the quantum circuit device 212 or other quantum circuit devices on the device wafer 202. In some instances, the control line 224 is a planar transmission line (e.g., coplanar waveguides, substrate integrated waveguides, or another type of planar transmission line). For example, the control line 224 may be implemented as the coplanar waveguides 512, 712 shown in FIGS. 5A-5B, 7A-7B, 13A-13B.

In some examples, the control line 224 is a flux bias line, a combined flux bias and qubit drive line, or another type of control line for communicating other types of control signals. In this case, the circuit loop 226 is inductively coupled to the SQUID loop 216, the frequency of the quantum circuit device 212 can be tuned by applying a magnetic field through the SQUID loop 216. The magnetic field can be generated by the control line 224. The desired mutual inductance can be achieved by adjusting the distance between the circuit loop 226 and the SQUID loop 216. In some cases, the distance between the circuit loop 226 and the SQUID loop 216 is defined by the distance between the two surfaces 206, 222.

In some examples, the control line 224 is a microwave line. In this case, the control line 224 may be coupled to the quantum circuit device 212 on the device wafer 202 capacitively through the qubit electrodes 214A, 214B. The capacitive coupling and the inductive coupling between the quantum circuit device 212 and the control line 224 can be set by the relative positions and distance of the cap wafer 204 and the device wafer 202. The state of the quantum circuit device 212 can be manipulated by sending microwave pulses along the control line 224.

In some instances, the control line 224 which is capacitively and inductively coupled to the quantum circuit device 212 is a combined flux bias and qubit drive line. In this case, the control signal on the control line 224 can include a low-frequency component (e.g., typically with a highest frequency value up to ˜500 MHz or a different value) and a high-frequency component at or near the qubit frequency (e.g., typically about 4 GHz or a different value). The low-frequency component in the circuit loop 226 generates a local magnetic field that interacts with the SQUID loop 216 of the quantum circuit device 212 and tunes the frequency of the quantum circuit device 212. In this case, the low-frequency component of the current bias is a flux bias signal. The high-frequency component interacts capacitively with the qubit electrodes 214A, 214B of the quantum circuit device 212 and causes the wavefunction in the qubit to change in a controlled fashion. The high-frequency component of the current bias is a microwave drive signal.

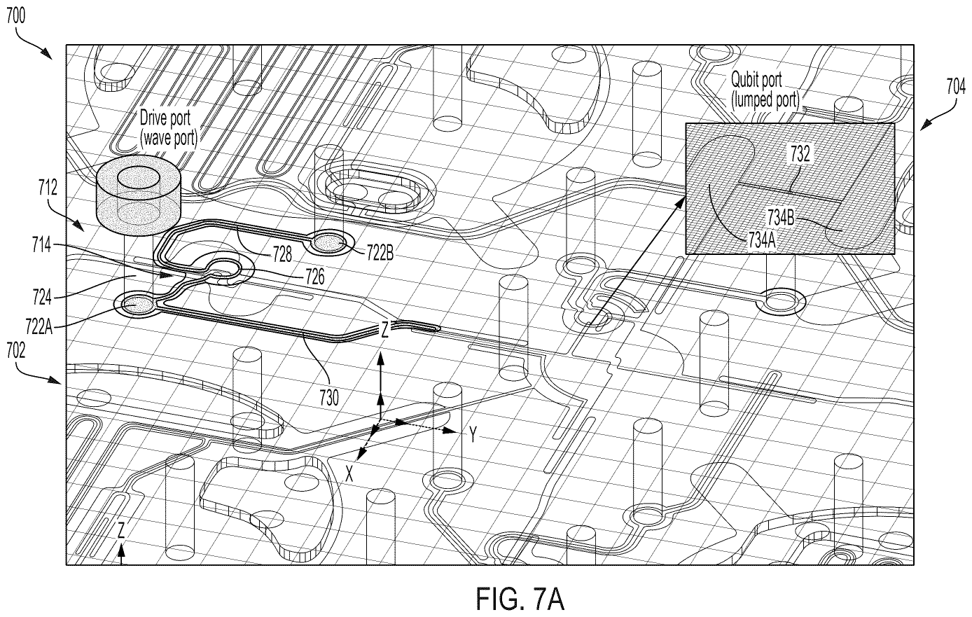

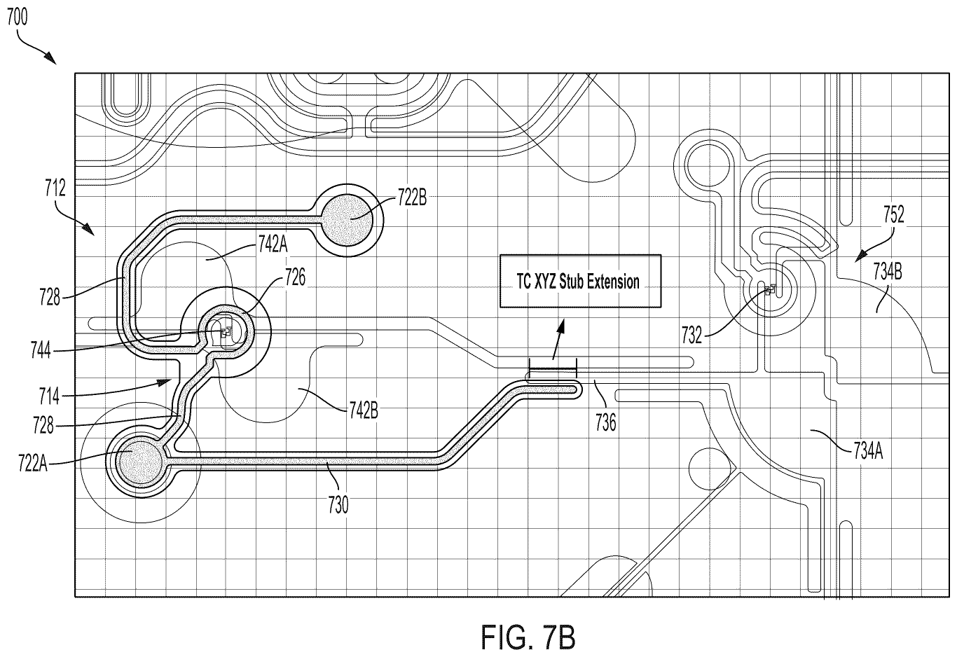

In some implementations, the capacitive tuning element 228 of the control line 224 is configured to modify a differential capacitance between the control line 224 and each of the qubit electrodes 214A, 214B; and to tune a coupling strength between the control line 224 and the quantum circuit device 212. In some instances, the capacitive tuning element 228 may be a transmission line branch galvanically connected to and extended from the conductive traces 225 of the control line 224, e.g., an extended microstrip transmission line, a curved microstrip transmission line, a pad, or another shape. In some instances, the capacitive tuning element 228 extended from the conductive traces 225 may be connected to the conductive traces 225 at any position (e.g., as shown in FIGS. 5A-5B and 7A-7B). In some instances, the capacitive tuning element 228 may be part of the conductive traces 225 (e.g., a wider section of the conductive traces 225, a segment of the conductive traces 225 that may be coated with a dielectric material with higher dielectric constant). Tuning the design parameters of the capacitive tuning element 228 may include tuning the geometry or material properties of the control line 224. In some implementations, design parameters of the capacitive tuning element 228, such as location, size, shape, etc., are configured to obtain a balanced gate performance (e.g., a fast gate time and a long Purcell limited decoherence time) according to one or more predefined constraints. For example, geometric dimensions, positions, shapes, and other properties of the capacitive tuning element 228 can affect the coupling strength between the control line 224 and the quantum circuit device 212 by asymmetrically affecting the capacitance between the control line 224 and each of the two qubit electrodes 214A, 214B. For example, the capacitive tuning element 228 is configured to asymmetrically increase the capacitance between the control line 224 and the nearest qubit electrode 214B. In some instances, one or more capacitive tuning element 228 may be further included to the control line 224 to reduce its parasitic coupling to other neighboring, non-associated quantum circuit devices. In some instances, the capacitive tuning element 228 may reside on the device wafer 202 connected to one of the qubit electrodes 214A, 214B.

In some implementations, initial design parameters of the one or more capacitive tuning element 228 of the control line 224 are determined by performing a numerical simulation (e.g., full-wave electromagnetic simulation, quasi-electrostatic simulation, and other simulation); and may be further revised or modified according to an empirical measurement of driveability (as defined in Equations 35-38 below) of the quantum circuit device 212 through the control line 224 in an actual setup (e.g., the control system, the signal delivery system, the cryostat, etc.). In some instances, the design parameters for the one or more capacitive tuning elements 228 of a control line 224 can be determined according to the operations in the example process 400, 1000 in FIGS. 4, 10, or in another manner.

In certain instances, each of the device wafer 202 and the cap wafer 204 may include a substrate which may be an elemental semiconductor, for example silicon (Si), germanium (Ge), selenium (Se), tellurium (Te), or another elemental semiconductor. In some instances, the substrate may also include a compound semiconductor such as aluminum oxide (sapphire), silicon carbide (SiC), gallium arsenic (GaAs), indium arsenide (InAs), indium phosphide (InP), silicon germanium (SiGe), silicon germanium carbide (SiGeC), gallium arsenic phosphide (GaAsP), gallium indium phosphide (GaInP), or another compound semiconductor. In some instances, the substrate may also include a superlattice with elemental or compound semiconductor layers. In certain instances, the substrate includes an epitaxial layer. In some examples, the substrate may have an epitaxial layer overlying a bulk semiconductor or may include a semiconductor-on-insulator (SOI) structure.

In some implementations, the qubit electrodes 214A, 214B on the device wafer 202, the control line 224 on the cap wafer 204, and the ground plane on the device and cap wafer 202, 204 include superconductive materials and can be formed by patterning one or more superconductive (e.g., superconducting metal) layers or other materials on the surface of the substrate. In some implementations, each of the one or more superconductive layers include a superconducting metal, such as aluminum (Al), niobium (Nb), tantalum (Ta), titanium (Ti), vanadium (V), tungsten (W), zirconium (Zr), or another superconducting metal. In some implementations, each of the one or more superconductive layers may include a superconducting metal alloy, such as molybdenum-rhenium (Mo/Re), niobium-tin (Nb/Sn), or another superconducting metal alloy. In some implementations, each of the superconductive layers may include a superconducting compound material, including superconducting metal nitrides and superconducting metal oxides, such as titanium-nitride (TiN), niobium-nitride (NbN), zirconium-nitride (ZrN), hafnium-nitride (HfN), vanadium-nitride (VN), tantalum-nitride (TaN), molybdenum-nitride (MoN), yttrium barium copper oxide (Y—Ba—Cu—O), or another superconducting compound material. In some instances, the qubit electrodes 214A, 214B and the ground plane may include multilayer superconductor-insulator heterostructures.

In some implementations, the control lines 224, the quantum circuit device 212, and the ground plane are fabricated on the top surfaces of the respective substrates and patterned using a microfabrication process or in another manner. For example, the qubit electrodes 214A, 214B, the control lines 224, the quantum circuit device 212, and the ground plane may be formed by performing at least some of the following fabrication steps: using chemical vapor deposition (CVD), physical vapor deposition (PVD), atomic layer deposition (ALD), spin-on coating, and/or other suitable techniques to deposit respective superconducting layers on the substrate; and performing one or more patterning processes (e.g., a lithography process, a dry/wet etching process, a soft/hard baking process, a cleaning process, etc.) to form openings in the respective superconducting layers.

FIG. 2B is a schematic diagram of a top view of an example superconducting quantum processing unit 230. The example superconducting quantum processing unit 230 includes superconducting circuitry with quantum circuit devices. As shown in FIG. 2B, the quantum circuit devices in the example superconducting quantum processing unit 230 include tunable-frequency qubit devices 232A, 232B, 232C, 232D communicably coupled to a tunable-frequency qubit device 232E through respective tunable-frequency coupler devices 234A, 234B, 234C, 234D. Each of the tunable-frequency qubit devices 232A, 232B, 232C, 232D, 232E and each of the tunable-frequency coupler devices 234A, 234B, 234C, 234D may be implemented as the quantum circuit devices 212 in FIG. 2A.

In some examples, the tunable-frequency qubit devices 232A, 232B, 232C, 232D, 232E and the tunable-frequency coupler devices 234A, 234B, 234C, 234D may be implemented by other types of systems, and the features and components represented in FIG. 2B can be extended in a larger two-dimensional or three-dimensional array of devices. For example, each of the tunable-frequency qubit devices 232A, 232B, 232C, 232D may be further coupled to a distinct tunable-frequency qubit device through a distinct tunable-frequency coupler device. In some implementations, the example superconducting quantum processing unit 230 represents a 5-qubit system in a device array with a square lattice. The example superconducting quantum processing unit 230 may include additional or different features and components, which may be configured in another manner. For example, the quantum processing unit 230 may include respective readout resonator devices associated with the tunable-frequency qubit devices 232A, 232B, 232C, 232D, 232E for performing readout operations.

Each of the tunable-frequency qubit devices 232A, 232B, 232C, 232D, 232E and the tunable-frequency coupler devices 234A, 234B, 234C, 234D includes a SQUID loop 238 that has two Josephson junctions 240 connected in parallel. In some implementations, each of the SQUID loops 238 can be inductively coupled to (has a mutual inductance with) a respective control line 244, 246, which can individually tune a magnetic flux in a respective superconducting circuit loop. The control lines 244, 246 are connected to an external control system (e.g., the control system 105 in FIG. 1) which is configured to generate respective flux control signals. In some instances, the tunable-frequency qubit devices 232A, 232B, 232C, 232D, 232E and the tunable-frequency coupler devices 234A, 234B, 234C, 234D may include additional or different features, and may operate as described with respect to FIG. 2B or in another manner. For example, each of the SQUID loops 238 may include more than two Josephson junctions or may be configured in another manner.

As shown in FIG. 2B, each of the tunable-frequency qubit devices 232A, 232B, 232C, 232D, 232E and the tunable-frequency coupler devices 234A, 234B, 234C, 234D includes a pair of qubit electrodes 242. Each pair of qubit electrodes 242 is electrically floating at a certain potential without being conductively connected to a ground plane. In other words, the qubit electrodes 242 are capacitively coupled to the ground plane. In this case, each of the tunable-frequency qubit devices 232A, 232B, 232C, 232D, 232E and the tunable-frequency coupler devices 234A, 234B, 234C, 234D is floating.

As shown in FIG. 2B, the example superconducting quantum processing unit 230 includes control lines 244, 246 (e.g., flux bias control lines and/or XY qubit control lines) that a control system (e.g., the control system 105A,B shown in FIG. 1) uses for providing control signals to respective tunable-frequency qubit devices 232 and respective tunable-frequency coupler devices 236 (e.g., to activate or deactivate coupling between a pair of tunable-frequency qubit devices) and performing two-qubit quantum logic gates, or other types of quantum control operations. In particular, the quantum processing unit 230 includes qubit control lines 244A, 244B, 244C, 244D, 244E for respective tunable-frequency qubit devices 232A, 232B, 232C, 232D, 232E; and coupler control lines 246A, 246B, 246C, 246D for respective tunable-frequency coupler devices 234A, 234B, 234C, 234D.

In some instances, each control line 244, 246 is inductively coupled to a respective SQUID loop 238 of the respective quantum circuit device. In some instances, each control line 244, 246 may be also capacitively coupled to each of the two electrodes 242 from the same quantum circuit device. In certain instances, each of the two electrodes 242 may be also capacitively coupled to nearby control lines associated with neighboring quantum circuit devices, e.g., through parasitic capacitance. In some implementations, each qubit control line 244A, 244B, 244C, 244D, 244E and the coupler control lines 246A, 246B, 246C, 246D includes a capacitive tuning element 248. In some implementations, a capacitive tuning element 248 is conductively connected to a control line 244, 246. In some instances, the capacitive tuning element 248 may be implemented as the capacitive tuning element 228 in FIG. 2A or in another manner. Design parameters (e.g., geometry, shape, location relative to the qubit electrodes, etc.) of each capacitive tuning element 248 can be determined according to the operations in the example process 400, 1000 as shown in FIGS. 4, 10 or in another manner. In some instances, the design parameters of each capacitive tuning element 248 are determined and optimized according to one or more predefined constraints considering balanced gate performance (e.g., fast gate time), long decoherence time, or other parameters.

The tunable-frequency qubit devices 232A, 232B, 232C, 232D, 232E and the tunable-frequency coupler devices 234A, 234B, 234C, 234D shown in FIG. 2B resides on the top surface of a substrate 250. In certain instances, the substrate 250 may be implemented as the substrate 202 in FIG. 2A. The superconducting circuitry of the superconducting quantum processing unit 230 includes superconductive materials and can be formed by patterning one or more superconductive (e.g., superconducting metal) layers or other materials on the surface of the substrate 250. The control lines 244, 246 may reside on a surface of a different substrate separated from the substrate 250.

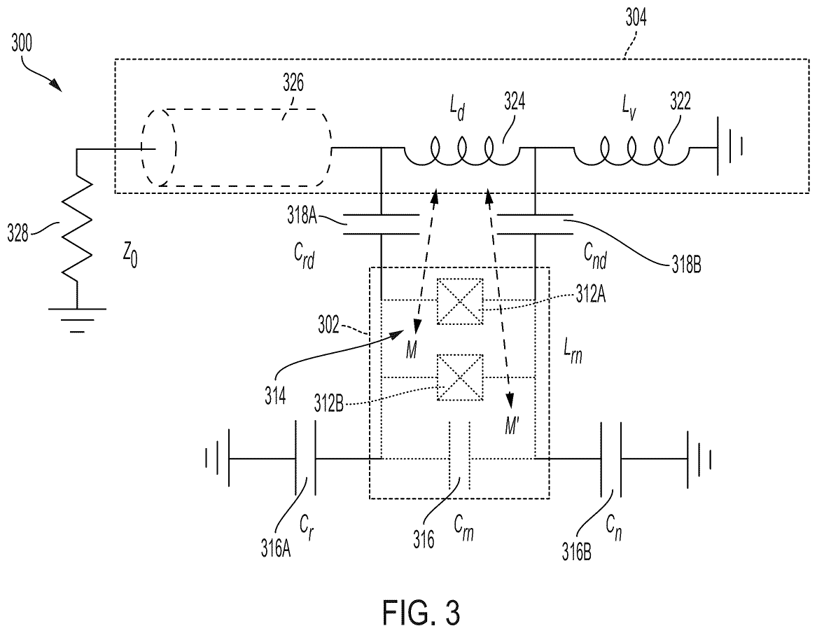

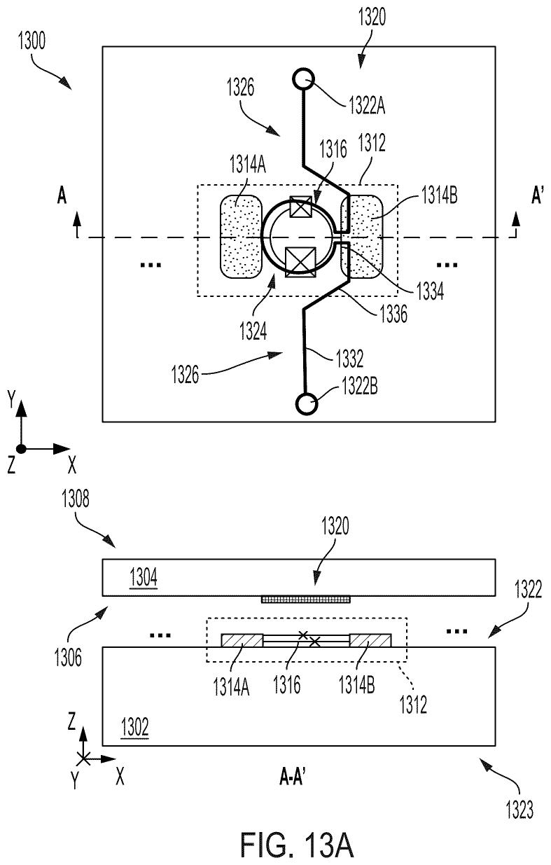

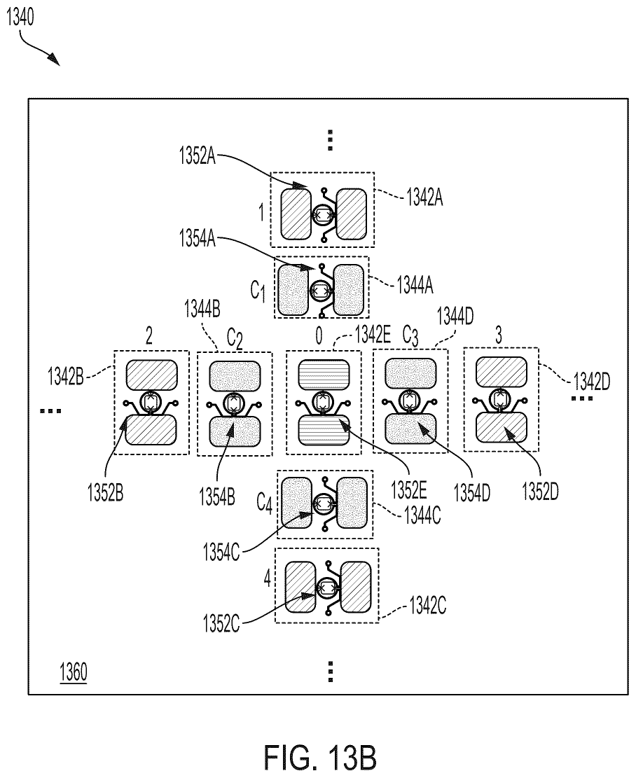

FIG. 3 is a circuit diagram showing an example equivalent circuit 300 of the example quantum processing unit 200 in FIG. 2A. The example equivalent circuit 300 represented in FIG. 3 includes a tunable-frequency qubit device 302 and a control line 304. For instance, the equivalent circuit 300 in FIG. 3 can represent the tunable-frequency floating qubit device 212, 1312 and the control line 224, 1320 in the quantum processing unit 200, 1300 in FIGS. 2A, 13A, or the equivalent circuit 300 in FIG. 3 can represent other quantum circuit devices (e.g., a tunable-frequency coupler device and its associated control line) in another type of system or environment.

As shown, the tunable-frequency qubit device 302 includes two Josephson junctions, e.g., a first Josephson junction 312A and a second Josephson junction 312B. The first and second Josephson junctions 312A, 312B having Josephson energies E_{J1} and E_{J2} are connected in parallel with each other to form a SQUID loop 314. The tunable-frequency qubit device 302 also includes a shunt capacitor 316 with a capacitance Cᵣₙ, which is connected in parallel with the two Josephson junctions 312A, 312B. In some instances, the shunt capacitor 316 is introduced by two qubit electrodes of the tunable-frequency qubit device 302, e.g., the two qubit electrodes 214A/214B, 1314A/1314B as shown in the tunable-frequency floating qubit device 212, 1312 in FIGS. 2A and 13A.

The tunable-frequency qubit device 302 is capacitively coupled to the ground plane through respective residual capacitors. Particularly, the tunable-frequency qubit device 302 is coupled to the ground plane via residual capacitors 316A, 316B having respective capacitances Cᵣ and Cₙ. As shown in FIG. 3, the tunable-frequency qubit device 302 is capacitively coupled to the control line 304 via respective residual capacitors. Particularly, the tunable-frequency coupler device 302 is coupled to the control line 304 via residual capacitors 318A, 318B with respective capacitances C_{rd}, and C_{nd}. In some instances, the residual capacitors 318A, 318B are caused by the capacitance between the respective qubit electrodes and the control line 304. In some instances, the tunable-frequency qubit device 302 may be a tunable-frequency transmon device. In certain instances, the tunable-frequency qubit device 302 may be a tunable-frequency coupler device configured between two qubit devices in a device lattice, e.g., as shown in FIGS. 2B, 13B.

In some instances, only one of the qubit electrodes is connected to a readout resonator device; and the other qubit electrode is not connected to any resonator. A coupling component (e.g., a circuit loop) of the control line 304 is approximated as an inductor, opposite sides of which are capacitively coupled to the respective qubit electrodes 318A, 318B. The coupling component of the control line 304 has a mutual inductance coupling to the SQUID loop 314 (M); and a mutual inductance coupling to the remaining transmon circuit (M′). Lᵣₙ represents the total inductance provided by both Josephson junctions. The control line 304 providing the signal has characteristic impedance 328 Z₀ and the line shunts to the ground plane at a short distance after the qubit device 302, functioning like a small inductor 322 with an inductance of Lᵥ. L_{d} 324 is a placeholder self-inductance for the control line, e.g., the portion of the control line 304 that generates inductive coupling the SQUID loop 314. The control line 304 includes a generic transmission line 326, for example, a coaxial line or a planar waveguide. In some instances, the control line 304 may include passive or active radio frequency devices including for example attenuators, filters, isolators, circulators, or other circuit components.

In some implementations, the control line 304 resides in a proximity to the tunable-frequency qubit device 302 and is weakly coupled both inductively and capacitively. The infinite transmission line providing the signal, from the perspective of the tunable-frequency qubit device 302, can be treated as a resistor equal to the characteristic impedance Z₀ of the control line 304 to ensure no reflection of any signal that enters the control line 304. On the opposite side is a small transmission line which shorts to the ground plane, functioning like a small inductor 322 with an inductance Lᵥ. The equivalent circuit 300 in FIG. 3 can be represented by the capacitance (C), conductance (G), and inverse inductance matrices (K)

$$C = ( \begin{matrix}{C}_{r} + {C}_{r n} + {C}_{rd} & - {C}_{r n} & - {C}_{rd} & 0 \\ - {C}_{r n} & {C}_{n} + {C}_{r n} + {C}_{nd} & 0 & - {C}_{nd} \\ - {C}_{rd} & 0 & {C}_{rd} & 0 \\ 0 & - {C}_{nd} & 0 & {C}_{nd}\end{matrix} ) \qquad ( 1 )$$

$${G}_{ij} = \frac{{δ}_{i 3} {δ}_{j 3}}{{Z}_{0}} \qquad ( 2 )$$

$$K = ( \begin{matrix}{K}_{r n} & - {K}_{r n} & - {K}_{{M}^{′}} & {K}_{{M}^{′}} \\ - {K}_{r n} & {K}_{r n} & {K}_{{M}^{′}} & - {K}_{{M}^{′}} \\ - {K}_{{M}^{′}} & {K}_{{M}^{′}} & {K}_{d} & - {K}_{d} \\ {K}_{{M}^{′}} & - {K}_{{M}^{′}} & - {K}_{d} & {K}_{d} + {K}_{v}\end{matrix} ) \qquad ( 3 )$$

$$where$$

$$\begin{matrix}{K}_{r n} = \frac{{L}_{d}}{{L}_{r n} {L}_{d} - {M}^{′2}} , \\ {K}_{d} = \frac{{L}_{r n}}{{L}_{r n} {L}_{d} - {M}^{′2}} , \\ {K}_{{M}^{′}} = \frac{{M}^{′}}{{L}_{r n} {L}_{d} - {M}^{′2}} , \\ {K}_{ν} = \frac{1}{{L}_{ν}} .\end{matrix} \qquad ( 4 )$$

The effective admittance of the tunable-frequency qubit device 302 can be computed by taking

$${Y}_{eff} ( s ) = {[ {{P}^{T} ( \frac{K}{s} + G + C s )}^{- 1} P ]}^{- 1} \qquad ( 5 )$$

$${P}^{T} = ( \begin{matrix}1 & - 1 & 0 & 0\end{matrix} ) \qquad ( 6 )$$

where P is a port matrix that defines the transmon flux coming from the Maxwell form of the admittance matrices. The effective admittance can be expressed in the form

$${Y}_{eff} ( s ) = \frac{{K}_{q}}{s} + {C}_{q} s + {Y}_{e n v} ( s ) , \qquad ( 7 )$$

$${K}_{q} = \frac{1}{{L}_{r n}} , {C}_{q} \approx {C}_{rn} + \frac{{C}_{r} {C}_{n}}{{C}_{r} + {C}_{n}} \qquad ( 8 )$$

$$Re [ {Y}_{e n v} ( i {ω}_{q} ) ] \approx {( \frac{{M}^{′}}{{L}_{r n}} + \frac{\frac{{C}_{rd}}{{C}_{r}} ( {L}_{d} + {L}_{v} ) - \frac{{C}_{n d}}{{C}_{n}} {L}_{v}}{\frac{1}{{C}_{r}} + \frac{1}{{C}_{n}}} {ω}_{q}^{2} )}^{2} \frac{{Z}_{0}}{{Z}_{0}^{2} + {( {L}_{d} + {L}_{v} )}^{2} {ω}_{q}^{2}} \qquad ( 9 )$$

The decay rate Γ₁ is given by

$${Γ}_{1} \approx \frac{Re [ {Y}_{e n v} ( i {ω}_{q} ) ]}{{C}_{q}} \qquad ( 10 )$$

where

$${ω}_{q} \approx \sqrt{\frac{{K}_{q}}{{C}_{q}}} .$$

In the weak coupling expansion in Eq. (9) only the lowest order terms in where M′, C_{rd} and C_{nd} may be considered. In this case, the admittance includes a net inductive and capacitive coupling attached to a lossy high-pass resistance-inductance filter. Note that in the absence of capacitive coupling to the control line 304, a standard form for inductive relaxation Γ₁ can be obtained.

Typically, the mutual inductance M′ has a small value. For a reasonable approximation and simplicity, M′ and L_{d} are set to zero. The reduced expression of the coupling strength X_{qd} and the decay rate Γ₁ can be expressed as

$${Γ}_{1} \approx \frac{{χ}_{q d}^{2} {C}_{q} {Z}_{0} {L}_{ν}^{2} {ω}_{q}^{4}}{{Z}_{0}^{2} + {L}_{ν}^{2} {ω}_{q}^{2}} \qquad ( 11 )$$

$${χ}_{qd} ≡ \frac{1}{{C}_{q}} \frac{\frac{{C}_{rd}}{{C}_{r}} - \frac{{C}_{nd}}{{C}_{n}}}{\frac{1}{{C}_{r}} + \frac{1}{{C}_{n}}} \qquad ( 12 )$$

The coupling mechanism is mediated capacitively through X_{qd}, which features a competition between each qubit electrode. The magnitude of qubit device-control line coupling is a function of the asymmetric capacitance in these two couplings. In other words, the magnitude of qubit device-control line coupling is determined by a differential capacitance which defines a difference in capacitance values, C_{rd} and C_{nd}. In some instances, the coupling can be minimized or otherwise reduced without having to minimize either C_{rd} or C_{nd}, which would be challenging in the presence of parasitic capacitance and would be very much specific to a given circuit layout and Hamiltonian. Instead, an additional design parameter can be introduced which is relatively orthogonal to the circuit design/target Hamiltonian and the function of which is solely to set the asymmetry between C_{rd} and C_{nd}. This parameter can be tuned in simulation and fine tune it empirically. This design process of a capacitive tuning element is outlined in the example process 400, 1000 in FIGS. 4, 10 or in another manner.

In some instances, the grounded end of the control line 304 can alter the functional form of the loss rate. When ωg is sufficiently lower than

$$\frac{{Z}_{0}}{{L}_{v}} ,$$

the loss rate has the quartic dependence on frequency. With Z₀=50Ω and Lᵥ=0.64 nH, a typical value from simulation,

$$\frac{{Z}_{0}}{2 π {L}_{v}} \approx 12.4$$

GHz. While the loss rate is monotonic in frequency, it shifts to a quadratic dependence at higher values. Quartic dependence is a severe increase in loss and great benefits can be seen by lowering operating frequency.

In some implementations, qubit relaxation through neighboring tunable coupler drive lines follow much the same principles. The two-port model can be expressed:

$${Y}_{eff} ( s ) \approx ( \begin{matrix}\frac{{K}_{q}}{s} + {C}_{q} s & - {C}_{q d} s \\ - {C}_{q d} s & \frac{1}{{Z}_{0}} + \frac{{K}_{ν}}{s}\end{matrix} ) , \qquad ( 13 )$$

where C_{qd} is the effective net capacitive coupling of the tunable-frequency qubit device 302 to the control line 304, computed as a combination of direct coupling or mediated by a chain of capacitances through a tunable-frequency coupler device. The former tends to be significant a priori to any tuning scheme due to nearby signal vias. Any inductive coupling to the tunable-frequency coupler device is also mediated to the tunable-frequency qubit device 302 by charge coupling and therefore is even less of a concern than it is for the qubit device's own control line. The same tuning principle can be applied to symmetrize the net capacitance, and because the tunable-frequency coupler device does not need any XY drive, this coupling can be minimized from the qubit's vantage with an ideal case of C_{qd}=0.

Relaxation due to the mutual inductance M to the SQUID loop 314 is not considered in modifying the design parameters of the control line, but for completeness the analysis is included. The junction Hamiltonian can be expressed as

$${\hat{H}}_{J} = - {E}_{J Σ} cos ( \frac{π Φ}{{Φ}_{0}} ) cos \hat{φ} - {E}_{J Δ} sin ( \frac{π Φ}{{Φ}_{0}} ) sin \hat{φ} \qquad ( 14 )$$

where E_{jΣ}=E_{J1}+E_{J2}, E_{JΔ}≡E_{J1}−E_{J2}, Φ is the net flux through the SQUID loop and φ is the average flux through both Josephson junctions. Consider Φ=Φₑ+Φₑ, where Φₑ is the purposefully applied external flux; and Φₙ is flux noise. For a Taylor expansion in the noise, the leading contribution can be expressed as:

$${\hat{A}}_{Φ} ≡ \frac{\partial {\hat{H}}_{J}}{\partial Φ} {\vert}_{Φ = {Φ}_{e}} = \frac{π}{{Φ}_{0}} [ {E}_{J \sum } sin ( \frac{π {Φ}_{e}}{{Φ}_{0}} ) cos \hat{φ} - {E}_{J Δ} cos ( \frac{π {Φ}_{e}}{{Φ}_{0}} ) sin \hat{φ} ] \qquad ( 15 )$$

Using Fermi's Golden rule,

$${Γ}_{1} = \frac{1}{{ℏ}^{2}} \vert 〈 1 \vert {\hat{A}}_{Φ} \vert 0 〉 {\vert}^{2} {M}^{2} {S}_{I} ( {ω}_{q} ) , \qquad ( 16 )$$

$$〈 1 \vert {Â}_{Φ} \vert 0 〉 = - \frac{π {E}_{J Δ}}{{Φ}_{0}} {ξ}^{1 / 2} {e}^{- ξ / 2} cos ( \frac{π {Φ}_{e}}{{Φ}_{0}} ) , \qquad ( 17 )$$

$${S}_{I} ( ω ) \approx \frac{2 ℏ ω}{R} Θ ( ω ) , \qquad ( 18 )$$

where

$$ξ ≡ \sqrt{\frac{2 {E}_{C}}{{E}_{J \sum }}}$$

is the small expansion parameter for the transmon, Sₗ(ω) is the current noise from the control line 304 (approximated at sufficiently low temperature); and R is the effective impedance of the control line 304. This channel tends to be a small contributor.

Another loss mechanism that is worth considering is the dielectric loss mediated by the shunt capacitors. The charge contribution from the Hamiltonian is expressed

$${\hat{H}}_{C} = \frac{{\hat{Q}}^{2}}{2 {C}_{q}} , \qquad ( 19 )$$

with Taylor expansion in noise giving

$${\hat{A}}_{Q} ≡ \frac{\partial {\hat{H}}_{C}}{\partial \hat{Q}} = \frac{\hat{Q}}{{C}_{q}} . \qquad ( 20 )$$

The decay rate due to dielectric constant at a finite temperature can be expressed as:

$${Γ}_{1} = \frac{1}{{ℏ}^{2}} \vert 〈 1 \vert {\hat{A}}_{Q} \vert 0 〉 {\vert}^{2} {C}_{q}^{2} {S}_{V} ( {ω}_{q} ) , \qquad ( 21 )$$

$$〈 1 \vert {\hat{A}}_{Q} \vert 0 〉 = \frac{i {λ}_{01}}{2 \sqrt{ξ}} \frac{2 e}{{C}_{q}} , \qquad ( 22 )$$

$${λ}_{01} = 1 - \frac{1}{{2}^{3}} ξ - \frac{11}{{2}^{8}} {ξ}^{2} - … , \qquad ( 23 )$$

$${S}_{V} ( ω ) \approx 2 ℏω R Θ ( ω ) , \qquad ( 24 )$$

where

$$R = \frac{tan δ}{ω {C}_{q}}$$

is the resistance introduced by a lossy capacitor with tanδ the substrate where loss tangent and Sᵥ(ω) is ohmic loss due to presence of a resistor at sufficiently low temperature. The above expression can be reduced to

$${Γ}_{1} \approx \frac{\sqrt{8 {E}_{C} {E}_{J}} - {E}_{C}}{ℏ} tan δ , \qquad ( 25 )$$

$$\approx {ω}_{q} tan δ , \qquad ( 26 )$$

which roughly aligns with the classical result. Dielectric loss is particularly dominant at low frequencies and becomes significant at the qubit frequency if the loss tangent is large enough to supersede the contributions mediated by the control line.

Qubit relaxation through neighboring tunable coupler drive lines follow much the same principles. The two-port model can be expressed:

$${Y}_{eff} ( s ) \approx ( \begin{matrix}\frac{{K}_{q}}{s} + {C}_{q} s & - {C}_{q d} s \\ - {C}_{q d} s & \frac{1}{{Z}_{0}} + \frac{{K}_{ν}}{s}\end{matrix} ) , \qquad ( 27 )$$

where C_{qd} is the effective net capacitive coupling of the tunable-frequency qubit device 302 to the control line 304, computed as a combination of direct coupling or mediated by a chain of capacitances through the tunable coupler itself. The former tends to be significant a priori to any tuning scheme due to nearby signal vias. Any inductive coupling to the tunable coupler is also mediated to the qubit by charge coupling and therefore is even less of a concern than it is for the qubit device's own control line. The same tuning principle can be applied to symmetrize the net capacitance because the tunable coupler does not need any XY drive; and this coupling can be minimized from the qubit's vantage with an ideal case of C_{qd}=0.

The coupling can be simulated by simulating the admittance matrix between two ports (defined in terms of the circuit elements by Eq.22). The first port (1) is a wave port which is configured at the backside of the input via of the control line. The second port (2) is a 50Ω lumped port in place of the qubit's Josephson junction. The admittance can be simulated over a wide frequency range near a qubit frequency range of the qubit device (e.g., 4-5 GHz). Given that the admittance between the two ports (Y(1,2)) is predominantly linear over this qubit frequency range, this admittance value can be assumed to be dominated by the capacitive term. In some instances, this value may be used as an approximation of the XY coupling between a given control line and the qubit device. For a dimensionless measure, the coupling strength X_{qd} can be expressed as

$${χ}_{q d} = \frac{Im [ Y ( 1 , 2 ) ]}{Im [ Y ( 1 , 1 ) ]} \qquad ( 28 )$$

which returns a value akin to Eq. (12). The junction inductance can be neglected to ensure Y(1,1) is purely capacitive, under the assumption that inductive coupling is negligible anyway.

The sign of X_{qd} indicates the qubit electrode that the control line is coupled to. Similarly, by adding one capacitive tuning element towards the qubit electrodes that the control lines are more weakly coupled to, the XY coupling value can be forced to cross the zero-coupling point. Depending on the control line that is simulated, some finite amount of coupling (based off of previous simulations and calibrations) can be obtained, or zero coupling to that source can be obtained.

Measuring the absolute coupling strength between the control line and a given quantum circuit device (e.g., qubit device or coupler device) X_{qd} as defined in Eq. (12), is non-trivial given the long and complex signal chain. This chain begins at the control electronics at room temperature, continues down through the fridge, package and PCB and eventually through the signal vias on the cap (carrier) die. Presently, the transfer function at cryogenic temperatures is far from uniform across the qubit frequency range (e.g., 4-5 GHz), likely due to the presence of impedance mismatches in the signal chain.

This measurement of the Rabi oscillations provides the pulse amplitude and duration commanded from the room temperature electronics required to rotate the qubit by π radians in the Bloch sphere, v_{π} and t_{π} respectively. Theoretically, if the on-chip pulse amplitude was also known, these parameters could be related directly to the absolute coupling rate. The simple circuit model for a microwave drive line capacitively coupled to a qubit device, depicted in FIG. 3 can be considered. The classical circuit Hamiltonian is given by

$$\hat{H} = \frac{\tilde{\hat{Q}} ( t )}{2 {C}_{q}} + \frac{{\hat{Φ}}^{2}}{2 L} + {χ}_{q d} {V}_{d} ( t ) \tilde{\hat{Q}} \qquad ( 29 )$$

with \hat{\tilde{Q}}=C_{q}\hat{\dot{Φ}}−C_{qd}V_{d}(t) the renormalized charge variable for the circuit, C_{q} defined by Eq. (8) and C_{qd} the effective net coupling between the qubit and the drive. When the coupling to the drive line is weak, it is assumed the charge operator is roughly equivalent to that of the isolated LC oscillator, \hat{\tilde{Q}}≈\tilde{Q}. The Hamiltonian can be expressed in terms of raising and lowering operators

$$\hat{H} = ω ( {\hat{a}}^{†} \hat{a} + \frac{1}{2} ) - {χ}_{q d} {V}_{d} ( t ) i {Q}_{z p f} ( \hat{a} - {\hat{a}}^{†} ) , \qquad ( 30 )$$

where

$${Q}_{z p f} = \sqrt{\frac{ℏ}{{Z}_{q}}} and {Z}_{q} = \sqrt{\frac{{L}_{r n}}{{C}_{q}}}$$

is the impedance across the qubit terminals. Truncating this to the lowest energy transition only, â=>\hat{σ}, â^{†}→\hat{σ}⁺, the standard Hamiltonian for a two-level system and an additional time dependent drive can be obtained,

$$\hat{H} = - \frac{{ω}_{q}}{2} {\hat{σ}}_{z} + Ω {V}_{d} ( t ) {\hat{σ}}_{y} . \qquad ( 31 )$$

Written in this form, the coupling rate between the microwave drive line and the qubit device (a transverse coupling, as can be seen by the oy operator) is denned as

$$Ω = {χ}_{qd} \sqrt{\frac{ℏ}{2 {Z}_{q}}} .$$

When working in the rotating frame of the qubit device with the rotating wave approximation, a drive pulse at the qubit frequency in-phase (φ=0) results in a unitary operator

$${\hat{U}}_{rf , d}^{ϕ = 0} ( t ) = exp ( [ \frac{i}{2} Ω {V}_{0} {\int }_{0}^{t} s ( {t}^{′} ) {dt}^{′} ] {\hat{σ}}_{x} ) \qquad ( 32 )$$

A π pulse rotation of the qubit thus occurs when

$$Θ ( t ) = π = - Ω {V}_{0} {\int }_{0}^{t} s ( {t}^{′} ) {dt}^{′} \qquad ( 33 )$$

The integral of the pulse envelope can be related back to the time (or as sometimes defined in variable, tₘₐₓ) parameter by a constant A that will be shape-dependent. For example, A=1 for a flat pulse, whereas for the default Gaussian envelope

$$exp ( - \frac{{( t - {t}_{max} / 2 )}^{2}}{2 {σ}^{2}} )$$

in both measurement infrastructures with

$$σ = \frac{{t}_{max}}{16 \sqrt{2 ln 2}}$$

and time cut-off of

$${t}_{max} , A = \frac{1}{8} \sqrt{\frac{π}{ln 2}} Erf [ 4 \sqrt{ln 2} ] \approx 0. 266 .$$

The next step is to relate V₀ to the commanded voltage v. At the qubit frequency of the qubit device (e.g., 3-5 GHZ), the characteristic impedance of the coax (≈50Ω) is small relative to that of the effective coupling C_{qd} between the qubit and drive line. In recent designs, the latter is on the order of 1 fF. After accounting for the 60-70 dB of attenuation in the gate, the voltage drop across any remaining elements (e.g., diplexer, PCB line resistance, etc.) should be minimal and can be neglected.

With this in mind, the coupling rate 12 can be related to the pulse parameters for a calibrated π pulse, v_{π} and t_{π}=tₘₐₓ as

$$Ω = - \frac{π}{{A}^{′} {v}_{π} {t}_{π}} , \qquad ( 34 )$$

where A′ is a constant capturing the effects of the pulse shape, difference between commanded voltage (v_p in willow or scale in treeline) and tsunami output, and the signal chain more generally. Assuming A′ is relatively constant, “driveability” D can be related to the design parameter X_{qd}:

$$D = {A}^{′} Ω \qquad ( 35 )$$

$$= {A}^{′} {χ}_{qd} \sqrt{\frac{ℏ}{2 {Z}_{q}}} \qquad ( 36 )$$

$$∝ \frac{{χ}_{qd}}{\sqrt{{Z}_{q}}} \qquad ( 37 )$$

$$\begin{matrix}∝ \sqrt{{ω}_{q} {C}_{q}} {χ}_{qd} & ( 38 )\end{matrix}$$

In some implementations, the driveability D can be used as an experimental metric that should be directly related to the coupling rate and coupling capacitance, up to the transfer function A′, assumed to be constant for a given fridge configuration (e.g., all control lines will have a similar A′ and it will not vary significantly from cooldown to cooldown or device to device). In actuality, oscillations may be found in the transfer function across the tunable frequency range of the qubit corresponding to an impedance mismatch somewhere in the signal chain. An added benefit of these measurements is that the location of this mismatch can be identified from the period of the oscillations in order to reduce the mismatch. These oscillations result in variations in A′, and by consequence D, on the order of a factor of two for most qubits. A reasonable estimation of the true X_{qd} can be obtained by taking the median or mean averages out this effect. These assumptions have been tested by measuring the same designs over multiple cooldowns and sampling different parts of the transfer function. While the results at any particular frequency might differ due to the impedance mismatch, relatively good agreement in the median and mean of the distribution across the tunable range can be obtained.

Measurements for various different designed control line coupling strengths (with the strength tuned through the use of the tuning stubs described in FIGS. 7A-7B) can be conducted and the expected monotonically decreasing coupling strength behavior with tuning stub angle can be observed.

The driveability D which is directly related to the coupling strength between the control line and the quantum circuit device can be reliably measured, and that consequently, the design parameters of the capacitive tuning element connected to the control line to optimize the coupling strength as needed to achieve can be tuned, e.g., a specified It pulse time within the constraints of the control system (e.g., maximum pulse output amplitude). Referring back to Eq. (37), the Purcell limited relaxation rate

$${Γ}_{1} = \frac{1}{{T}_{1}}$$

may be related to our measurable quantity D:

$${Γ}_{1} \approx \frac{{χ}_{qd}^{2} {C}_{q} {Z}_{0} {L}_{v}^{2} {ω}_{q}^{4}}{{Z}_{0}^{2} + {L}_{v}^{2} {ω}_{q}^{2}} , \qquad ( 39 )$$

$$∝ {( \frac{D}{\sqrt{{ω}_{q} {C}_{q}}} )}^{2} \frac{{C}_{q} {Z}_{0} {L}_{v}^{2} {ω}_{q}^{4}}{{Z}_{0}^{2} + {L}_{v}^{2} {ω}_{q}^{2}} , \qquad ( 40 )$$

$$∝ \frac{{ω}_{q}^{3} {D}^{2} {L}_{v}^{2} {R}_{w}}{{R}_{w}^{2} + {L}_{v}^{2} {ω}_{q}^{2}} , \qquad ( 41 )$$

where using the relationship from Eq. (42) and assuming impedance matched transmission lines for the control lines, approximated Z₀ as a real resistance R_{w}, generally on the order of 50 Q as mentioned previously. Note that while the dependance on qubit frequency is somewhat complicated, Γ₁ falls somewhere between a linear and cubic dependence on ω_{q}. In the limit where ω_{q}<<Z₀/Lᵥ, the dependence is cubic whereas when ω_{q}>>Z₀/Lᵥ, the dependence is linear. Regardless, over the frequency range of the tunable-frequency qubit devices (e.g., 3-5 GHz), the impact of this frequency dependence is negligible compared to the variation in driveability.

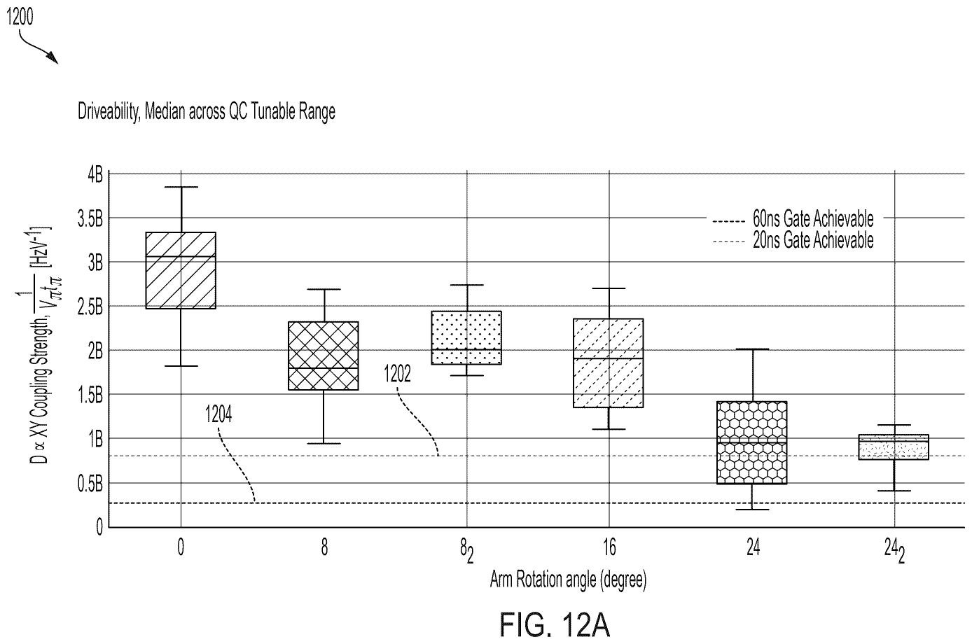

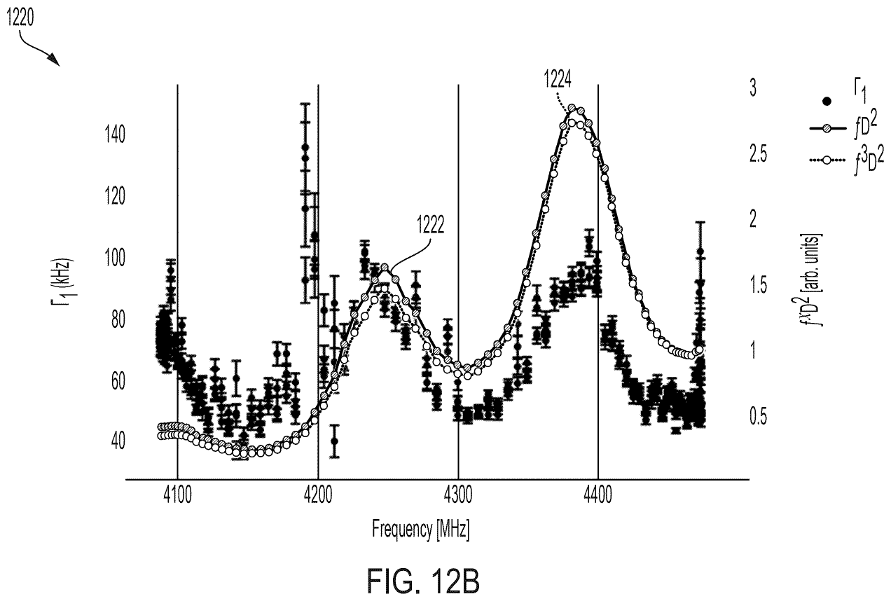

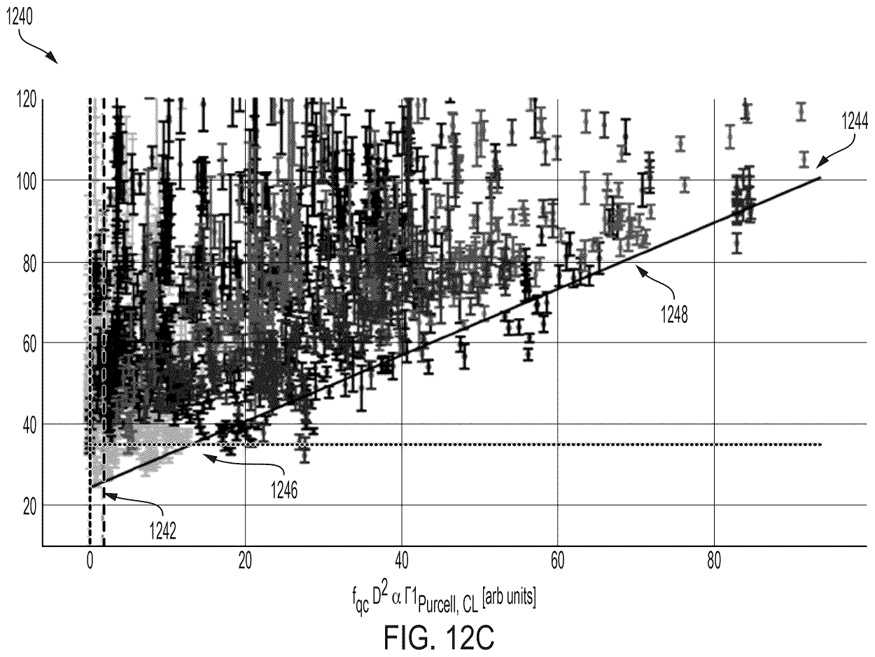

Measuring the Purcell limited relaxation rate Γ₁ might at first glance seem as simple as measuring 1 for various qubit devices with different driveability and looking for the correlation between Γ₁ and the sum of Eq. (45) over all neighboring or nearby control lines which have non-negligible coupling to the qubit device (R_{w} and Lᵥ are generally constant for a given fabrication process and package design). Identifying which control lines are relevant can be guided by simulation results of the coupling between the qubit and each control line and choosing for example, the N most highly coupled lines. In some implementations, this correlation will only exist if the measured Γ₁ is indeed Purcell limited, and not limited by something else such as coupling to a two-level system (TLS). In some instances, factors, either constant or varying, that could impact Γ₁ include strongly coupled coherent TLS, weakly coupled TLS fluctuators, and other factors. In some examples, an overall larger Γ₁ may be attributed to fabrication issues with a particular wafer. Fortunately, in the case of TLS, there are generally regions within the qubit frequency range of each qubit device where the qubit device is not coupled to a TLS. This is shown for a typical qubit in FIG. 12B, with the relaxation rate Γ₁ on the primary Y axis (on the left of the plot 1220) and the driveability of that qubit device overlayed on the secondary Y axis (on the right of the plot 1220 as a function of frequency).

FIG. 4 is a flow chart showing aspects of an example process 400. The example process 400 is used to determine design parameters of capacitive tuning elements to tune the qubit device-control line coupling. In some implementations, the example process is used to determine design parameters of one or more capacitive tuning elements for tuning the optimal coupling strength between a control line and a quantum circuit device. The quantum circuit device may be a tunable-frequency qubit device, a tunable-frequency coupler device, as shown in FIGS. 2A-2B, 3, 13, or other types of quantum circuit devices. The example process 400 can be used to determine design parameters of the one or more capacitive tuning elements according to the optimal coupling strength or other defined constraints to balance the gate performance and decoherence time. In some instances, the process 400 can be also used to determine design parameters for capacitive tuning elements connected to control lines that are on the same device wafer with the quantum circuit devices. In some instances, the process 400 may be also used to determine design parameters for capacitive tuning elements connected to the quantum circuit devices on the device wafer.

At 402, a design of first and second quantum processor wafers of a quantum processing unit is identified. In some instances, the first and second quantum processor wafers include superconducting circuitry. The superconducting circuitry meeting Hamiltonian requirements is designed. In some instances, a Hamiltonian can be obtained. The Hamiltonian can be decomposed into smaller steps that can be implemented using superconducting circuit. In certain examples, qubit architectures can be constructed from elements like Josephson junctions, capacitors, and inductors. The qubit architecture allows the implementation of terms in the Hamiltonian by controlling qubit frequencies and interactions. Based on the Hamiltonian requirements, a superconducting quantum processing unit can be constructed. For example, initial design parameters of superconducting circuitry (e.g., a qubit device and a respective control line), and initial configuration parameters of two quantum processor wafers can be determined. In some implementations, preliminary control line routing is identified.

In some instances, the design parameters of the control lines are modified to set asymmetry between C_{rd} and C_{nd}. In some instances, the design parameters of the control line may include the location, geometry, extension directions, number and angles of turns, and other parameters of the conductive traces, the circuit loop and the capacitive tuning element of the control line relative to the qubit electrodes of the qubit device.

At 404, simulation data is obtained from numerical simulations of the quantum processing system based on the design. In some instances, a simulation to extract the coupling strength X_{qd} as a function of the design parameters of the control line is performed. In some instances, the simulation is a full wave numerical simulation. In some instances, parameter range which covers a target range of the coupling strength can be determined. For example, a design parameter range of interest covering the target range of X_{qd} is determined. This is determined based on the target X_{qd} which will depend on the operational goals (e.g., it could be to minimize X_{qd}, minimize coupling to a spurious line, or to balance gate times with coherence times). It will also require choosing a range around this target value based on anticipated errors in the simulation/variation from simulation to reality. In some instances, admittance from the control line port to the qubit port as a function of control line routing geometry can be obtained from numerical full-wave electromagnetic simulations; and the control line coupling strength can be calculated. In certain examples, an ideal control line geometry can be determined based on the anticipated desired control line coupling.

At 406, experimental data is obtained from measurements of the quantum processing system manufactured according to the design. In some instances, the superconducting circuitry based on the design parameter range of interest covering the target range of X_{qd} is fabricated. In some implementations, the qubit electrodes, the control lines, the quantum circuit device, and the ground plane are fabricated on respective substrates and patterned using a microfabrication process or in another manner. For example, the qubit electrodes, the control lines, the quantum circuit device, and the ground plane may be formed by performing at least some of the following fabrication steps: using chemical vapor deposition (CVD), physical vapor deposition (PVD), atomic layer deposition (ALD), spin-on coating, and/or other suitable techniques to deposit respective superconducting layers on the substrate; and performing one or more patterning processes (e.g., a lithography process, a dry/wet etching process, a soft/hard baking process, a cleaning process, etc.) to form openings in the respective superconducting layers. In some instances, multiple superconducting circuits can be fabricated according to one set of design parameters; and different superconducting circuits with different design parameters may be fabricated.

The design parameters are empirically calibrated. In some instances, driveability and coherence time are measured on the fabricated superconducting circuits to empirically calibrate the design parameters. In some instances, the driveability can be measured according to the operations in the example process 1000 in FIG. 10 or in another manner. In some instances, the design parameters can be calibrated according to the one or more predefined constraints. For example, the design parameters that optimize gate performance (e.g., gate time), coherence time, loss rate or other constraints are determined.

At 408, the design of the control lines on the second quantum processor wafer is modified based on the simulation data and the experimental data. In some implementations, the design is modified by modifying a differential capacitance between the control line and the two qubit electrodes based on one or more predefined constraints. The one or more predefined constraints include one or more of the following: a minimum coherence time, a maximum gate time, a minimum energy loss, or another constraint. The differential capacitance is modified by modifying one or more geometries of the control line. For example, the arm rotation angle of the capacitive tuning element 530 in FIGS. 5A-5B can be modified; the stub length of the capacitive tuning element 730 in FIGS. 7A-7B can be modified; the length of the second section 1334 of the conductive traces 1326 in FIG. 13A can be modified; the angles and number of turns of the intermediate section 1336 can be modified; and other geometry of the control lines may be modified. In some implementations, the empirical relationship between loss rates, coupling speeds and driveability (which is linearly related to the coupling strength) can be used to fine tune the control line geometry, or determine the exact design modification based on the previously simulated relationship between control line geometry and coupling strength.

In some implementations, the methods and techniques presented here allow identification of an empirically measurable parameter which can be used to determine the relationship between the maximum achievable decoherence time on the quantum circuit device and the coupling strength (e.g., between the respective control line and the quantum circuit device). The determined relationship can be feedback to the simulation to guide the modification or refinement of the design parameters of the control lines to achieve optimal coupling strength according to one or more predefined constraints. For example, when the control lines reside on a cap wafer that is bonded to a device wafer where the quantum circuit device resides, the determined relationship can be used to modify the layout of superconducting circuitry on the cap wafer, including the location, the size, the number of segments, the direction, and other design parameters of the control lines on the cap wafer. In some cases, a combination of these and potentially other advantages and improvements may be obtained.

FIGS. 5A-5B are schematic diagrams showing a perspective view and a top view of an example quantum processing unit 500 of a quantum processing system. The example quantum processing unit 500 includes two quantum processor wafers, e.g., a device wafer 502 and a cap wafer 504, which may be implemented as the device wafer 202 and the cap wafer 204 in the example quantum processing unit 200 shown in FIG. 2A. The cap wafer 504 includes a control line 512 which includes a first control port 522A, a second control port 522B, conductive traces 526, a circuit loop 528, and a capacitive tuning element 530. The device wafer 502 includes a qubit device 514 which includes a SQUID loop 542 and two qubit electrodes 544A, 544B. In some instances, the control line 512 and the qubit device 514 may be implemented as the respective components in the example quantum processing unit 200 shown in FIG. 2. In some implementations, the example quantum processing unit 500 may include additional and different features or components; and components of the example quantum processing unit 500 may be implemented in another manner.

As shown in FIGS. 5A-5B, the conductive traces are galvanically connected between the circuit loop 528 and the control ports 522A, 522B. The capacitive tuning element 530 is galvanically connected to the conductive trace 526. The capacitive tuning element 530 is a curved planar transmission line. In some instances, the capacitive tuning element 530 may have another planar transmission line structure. The capacitive tuning element 530 extending from the conductive trace 526 to one qubit electrode 544B of the qubit device 514 on the device wafer 502. is configured to introduce additional capacitive coupling and modify a differential capacitance between the control line 512 and the two qubit electrodes 544A, 544B. The capacitance value of this additional capacitive coupling is parameterized by the arm rotation angle of the capacitive tuning element 530. In other words, adjusting the arm rotation angle of the capacitive tuning element 530 can effectively tune the asymmetric capacitance between the control line 512 and the qubit electrodes 544A, 544B so as to tune the overall coupling strength between the control line 512 and the qubit device 514. In some implementations, the qubit device 514 can be implemented as the tunable-frequency qubit device 212, 302, 1312 in FIGS. 2A, 3, 13A, or in another manner.

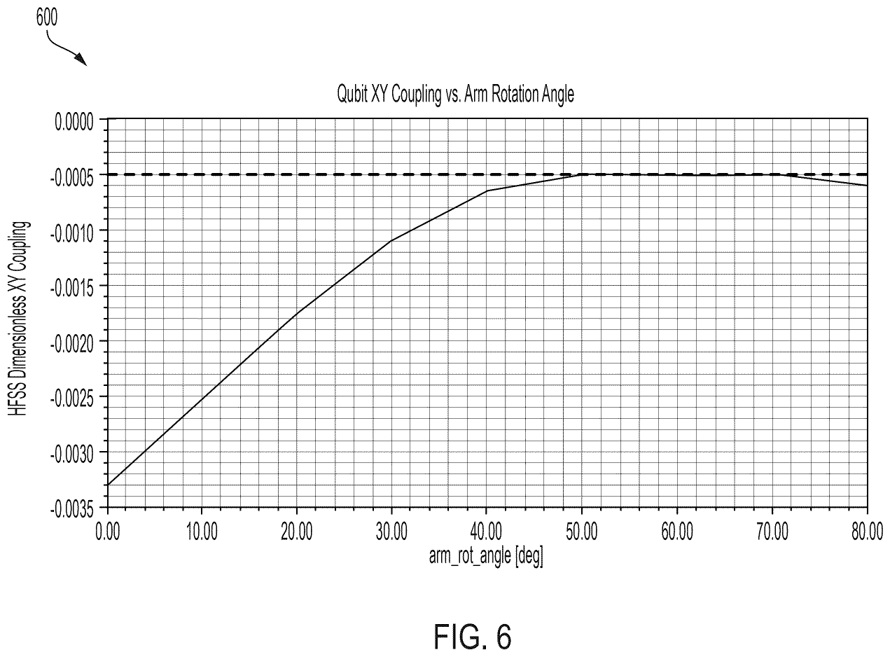

FIG. 6 is a plot 600 showing dimensionless qubit device-control line coupling as a function of the arm rotation angle of the capacitive tuning element 530 shown in FIGS. 5A-5B. In some instances, a wave port may be treated like a semi-infinite replica of the selected cross section. In this case, the cross-section is of a coaxial cable with a dielectric constant corresponding to a 50Ω impedance. As shown in FIG. 6, as the arm rotation angle increases from 0 to 60 degrees, the magnitude of the coupling strength reduces; and as the arm rotation angle further increases beyond 60 degrees, the magnitude of the coupling strength increases.

FIGS. 7A-7B are schematic diagrams showing perspective view and top view of an example quantum processing unit 700. The example quantum processing unit 500 includes two quantum processor wafers, e.g., a device wafer 702 and a cap wafer 704, which may be implemented as the device wafer 202, 502 and the cap wafer 204, 504 in the example quantum processing unit 200, 500 shown in FIGS. 2 and 5. The cap wafer 704 includes a control device 712 configured to apply control signals to a corresponding qubit device 714 on the device wafer 702. The qubit device 714 includes a pair of qubit electrodes 742A, 742B and a SQUID loop 744. In some instances, the qubit device 714 may be a tunable-frequency coupler device communicably coupled between two neighboring qubit devices 752 on the device wafer 702. As shown in FIGS. 7A-7B, the qubit device 752 is a tunable qubit device that includes a pair of qubit electrodes 734A, 734B and a SQUID loop 732. As shown in FIGS. 7A-7B, the qubit device 714 is a floating qubit device in which the qubit electrodes 742A, 742B are capacitively coupled to the ground.

As shown in FIGS. 7A-7B, the control device 712 includes a first control port 722A, a second control port 722B, a circuit loop 726, and control lines 728. In some implementations, each of the first and second control ports 722A, 722B includes a superconducting through-hole via configured to communicate control signals generated by an external control system from one surface of the cap wafer 704 to the control lines 728 and the circuit loop 726 on the opposite surface facing the qubit device 714 on the device wafer 702. The control device 712 may be a flux bias control line, a qubit drive line, or a combined flux bias and qubit drive line. In some implementations, the circuit loop 726 is inductively coupled to the SQUID loop of the qubit device 714; and the control lines 728 are capacitively coupled to the qubit electrodes 742A, 742B. In some implementations, the design of the circuit loop 726 and the control lines 728 are designed according to the operations of the example process 400, 1000, 1400 shown in FIGS. 4, 10, 14 or in another manner. For example, geometric configurations of the control device 712, e.g., length, extension directions, curvatures, turns, etc., can be modified by modifying a transfer function or a differential capacitance between the control device 712 and the qubit electrodes742A, 742B based on one or more predefined constraints, e.g., a minimum coherence time, a maximum gate time, a minimum energy lost, or another constraint.

As shown in FIGS. 7A-7B, the control device 712 further includes a capacitive tuning element 730. The capacitive tuning element 730 is a planar transmission line connected to the first control port 722A. In some instances, the capacitive tuning element 730 is configured to balance the coupling between the qubit device 714 and the qubit device 752 by introducing additional capacitive coupling to one of the neighboring qubit electrodes 734A of the neighboring qubit device 752. The capacitance value of this additional capacitive coupling is parameterized by a stub length of the capacitive tuning element 730 (e.g., the length of the section of the capacitive tuning element 730 overlapping with the extended section 736 of the qubit electrode 734A). In other words, adjusting the stub length of the capacitive tuning element 730 can effectively tune the capacitance between the control line 730 and the neighboring qubit device 752 so as to tune the overall coupling strength between the tunable-frequency coupler device (e.g., the qubit device 714) and the neighboring qubit device 752. In some implementations, the neighboring qubit device 752 can be implemented as the tunable-frequency qubit device 212, 302, 532 in FIGS. 2-3, 5 or in another manner. In some instances, the capacitive tunning element 730 may be designed and geometrical configurations of the capacitive tuning element 730 can be determined according to the operations in the example process 400, 1000, 1400 shown in FIGS. 4, 10, 1400 or in another manner.

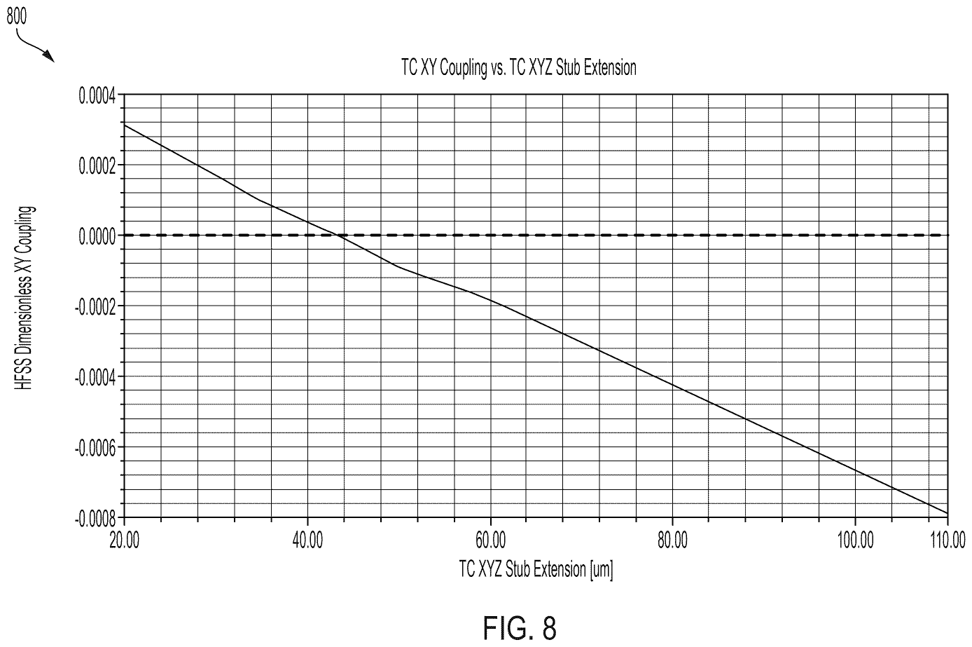

FIG. 8 is a plot 800 showing the coupling strength Xad as a function of the stub length of the capacitive tuning element 730 as shown in FIGS. 7A-7B. As the stub length increases from 20 μm to about 40 μm, the magnitude of the coupling strength reduces from positive values to zero; and as the stub length further increases from about 40 μm to 110 μm, the magnitude of the coupling strength increases; and the coupling strength changes its polarization e.g., to negative values.

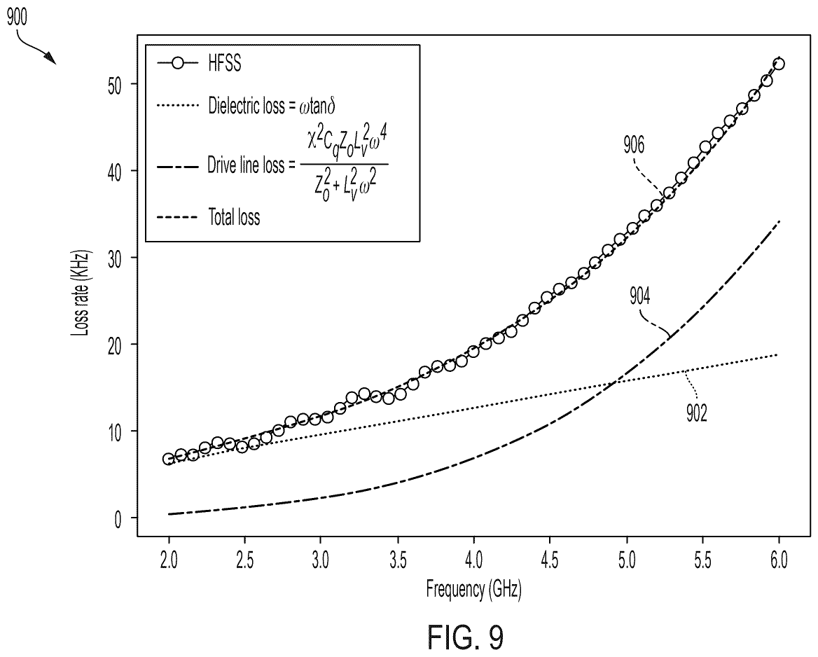

FIG. 9 is a plot 900 showing qubit loss rate in KHz as a function of the qubit frequency (f) in GHz. Analytical expressions for dielectric loss (curve 902) and drive line loss (curve 904) compare well with the simulations from HFSS. As shown in FIG. 9, the total loss (curve 906) matches well with the simulation results from HFSS. In order to capture both the low and high frequency trends, it is necessary to include the dielectric contribution which is linear in frequency and the drive line contribution which is quartic in frequency. Given that HFSS is a classical simulation, the anharmonicity is set to zero for the dielectric loss term. At the qubit frequency, both the contributions are relevant for silicon substrate (tanδ=9×10⁻⁷).

FIG. 10 is a flow chart showing aspects of an example process 1000 to empirically determine the driveability of a quantum circuit device through a control line in an actual setup (e.g., the control system, the signal delivery system, the cryostat, etc.). The quantum circuit devices may be tunable-frequency qubit devices as shown in FIGS. 2, 3, 5A-5B, 7A-7B, 13A-13B, or other types of quantum circuit devices. In some implementations, the example process 1000 may be implemented as the operation 406 in the example process 400.

In some instances, the radio-frequency pulse duration t which is required to shift the qubit phase by a fixed amount, Θ(t) can be measured. This pulse duration, t, can be related to the relative amplitude of the control line radiofrequency transfer function, A (ω), at the resonant frequency of the qubit, ω₀, through the Hamiltonian equations of motion of the qubit device. A (ω₀) is directly related to D, the driveability parameter defined in Equations 35-38 and the two can be treated as equivalent up to a frequency dependent constant. A(ω₀) can be correlated with the qubit loss rate, Γ₁(ω₀) as a function of qubit resonant frequency, wo to determine the transfer function amplitude at which the loss rate becomes dominated by loss through the control line, as evidenced by strong correlation between Γ₁ (ω₀) and A(ω₀). The empirically determined relationship between A(ω₀) and t, Γ₁(ω₀) can be leveraged to target a differential capacitance of the control line in the final device design to a value which optimizes these parameters for the application. In certain instances, optimizing includes minimizing the loss rate, Γ₁(ω₀), while providing the requisite maximum pulse duration, e.g., minimum gate speed, for a specific application. For intentional coupling to a control line, this minimum gate speed would be short (e.g., 20 ns) whereas for unintentional/parasitic coupling to a separate gate line, this would be very long, ideally infinite.

At 1002, the driveability and decoherence time are determined for a specific qubit frequency and control line design. The process 1002 includes sub-operations 1012, 1014, 1016 necessary to characterize some of the properties of the quantum circuit, in particular those which are relevant to optimize the control line geometry: the loss rate and driveability. In some instances, the properties may be characterized as a function of the qubit frequency if the qubit frequency is tunable with flux, e.g., when the qubit device includes a SQUID. The suboperations 1012, 1014, 1016 are performed repeatedly over a large range of driveablity accumulating a sufficiently large dataset (hundreds to thousands of data points) for statistical analysis.

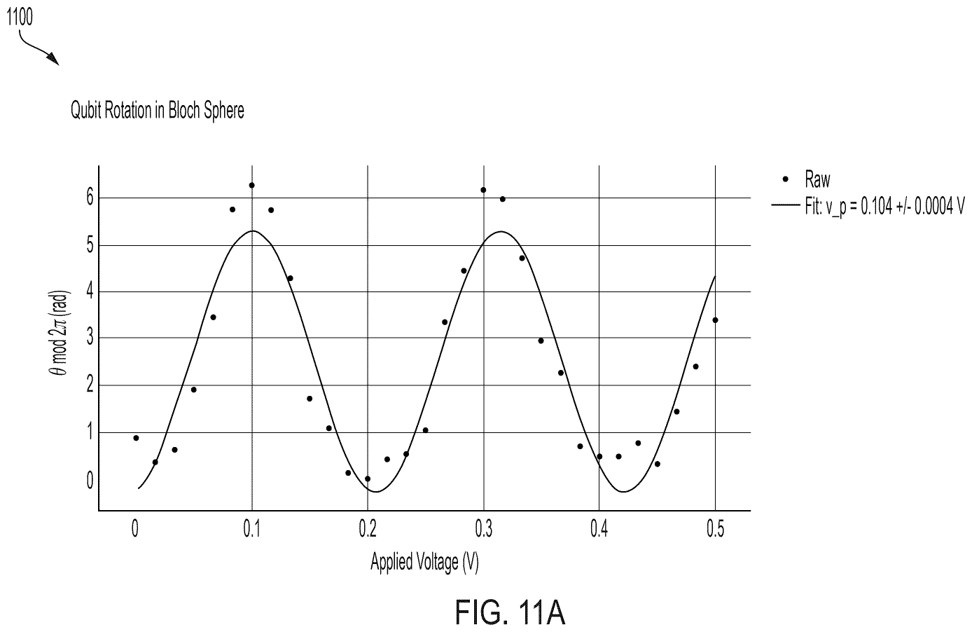

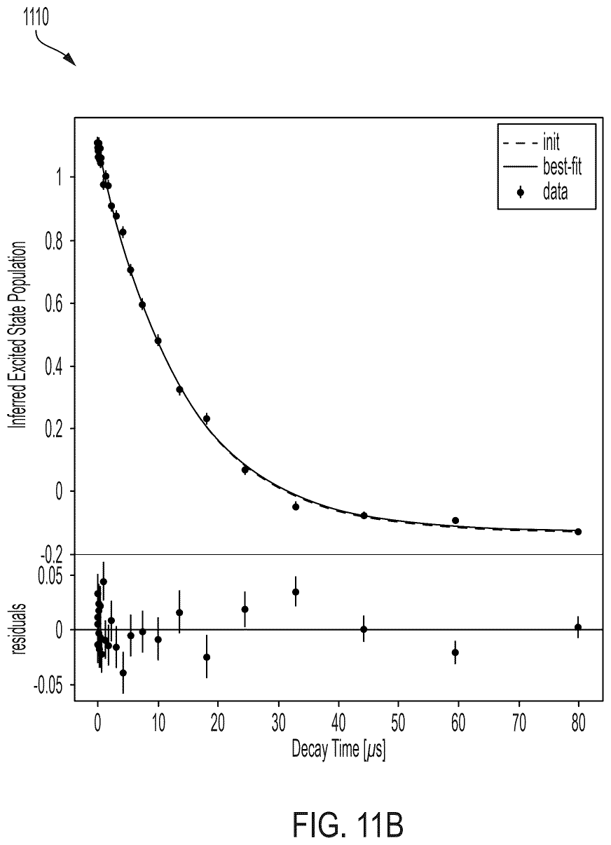

At 1012, rotation of the qubit in the Bloch sphere as a function of voltage applied to the control line is measured. In some instances, the relationship between the applied voltage of a fixed-duration radio-frequency pulse at the qubit frequency to the control line port, and the rotation of the qubit in the Bloch sphere as measured by the projection of the qubit state onto the measurement axis is measured. The result of such a measurement is shown in FIG. 11A, which depicts the qubit rotation angle as a function of applied voltage.

In some instances, prior to the measurement, the quantum circuit device is calibrated. In some implementations, a calibration process is performed to determine control parameters of control signals. In some instances, device parameters of the quantum circuit devices can be obtained. For example, the device parameters of the qubit devices, coupler devices and other quantum circuit devices in the quantum processing unit are determined by performing a measurement or characterization process, a tune-up process, or another type of calibration process. In some instances, a measurement process can characterize a particular set of quantum circuit devices in the quantum processing unit. In some instances, the device parameters may be predetermined using another process, which then can be stored and obtained in another manner. For example, a measurement process can be executed to characterize all the quantum circuit devices in a quantum processing unit to obtain the device parameters of each of the qubit devices and coupler devices in a device array, for example, once a quantum processor is cooled down.

In some instances, device parameters that can be used to characterize a tunable-frequency qubit device include a tunable range of transition frequencies. In certain examples, a tunable range of transition frequencies is defined by a maximal frequency value, e.g., the |0 [symbol] →|1 [symbol] transition frequency value at a magnetic flux of zero flux quantum applied to the tunable-frequency qubit device,

$${ω}_{01} ( Φ = 0 ) ≡ {ω}_{01}^{max} \qquad ( 42 )$$

and a minimum frequency value, e.g., the |0 [symbol] →|1 [symbol] transition frequency value at a magnetic flux of half-flux quantum,

$${ω}_{01} ( Φ = \frac{{Φ}_{0}}{2} ) ≡ {ω}_{01}^{min} \qquad ( 43 )$$

anharmonicity at the magnetic flux of zero flux quantum,

$$η ( Φ = 0 ) ≡ {η}^{max} \qquad ( 44 )$$

and the qubit flux bias Φ, e.g.,

$$Q = Q ( {ω}_{01}^{max} , {ω}_{01}^{min} , {η}^{max} , Φ ) \qquad ( 45 )$$

where Q represents a collection of device parameters that can be used to describe a qubit device. In some implementations, a maximal frequency value may be at a different magnetic flux. For example, a maximal frequency value may be at a value offset from a magnetic flux of zero flux quantum, a magnetic flux of half flux quantum, or another value.

In some implementations, the device parameters may include one or more of the device parameters of the tunable-frequency qubit device in the quantum processing unit. For example, device parameters, such as a maximum transition frequency

$${ω}_{12}^{max} ,$$

anharmonicity (η) at

$${ω}_{12}^{max} ,$$

can be used to characterize the qubit implementation beyond the lowest two states. In some instances, device parameters further include periodicity, coupling strengths, and other device parameters can be calibrated, measured, and stored, e.g., in a database of the memory 112 of the server 108. In certain instances, circuit parameters of circuit components in an equivalent circuit representing quantum circuit devices in the quantum processing unit can be calculated based on the device parameters.

In some examples, the transition frequency of a tunable-frequency qubit device or a tunable-frequency coupler device from the ground state |0 [symbol] to the first excited state |1 [symbol] is measured by using qubit spectroscopy. Ramsey interferometry can then be used to fine tune the value of the transition frequency obtained from the spectroscopic measurement. In some instances, the transition frequency can be measured at one or more reference values of the applied magnetic flux. For example, the transition frequency of a tunable-frequency qubit device can be measured at zero flux and one-half flux quantum; the tunable-frequency qubit devices may be measured under other flux conditions.

In some examples, after the transition frequencies of the tunable-frequency qubit device are obtained, qubit spectroscopy can be used to measure the transition frequency from the ground state |0 [symbol] to the second excited state |2 [symbol] which can be used to calculate the anharmonicity of the tunable-frequency qubit device. For instance, the absolute value of the anharmonicity of a tunable-frequency qubit device may be computed as |η [symbol] =|2ω₀₁−ω₀₂], where ω₀₁ represents the transition frequency from the ground state |0 [symbol] to the first excited state |1 [symbol] of the tunable-frequency qubit device, and ω₀₂ represents the transition frequency from the ground state |0) to the second excited state |2) of the tunable-frequency qubit device.

In some implementations, a control signal includes a flux bias signal that can be communicated to the tunable-frequency qubit device on a flux bias control line to tune the transition frequency. In some implementations, a control signal includes a flux modulation signal which can be communicated to the tunable-frequency qubit device on a flux bias control line to modulate the transition frequency. In certain instances, the control signal also includes a drive signal which can be communicated to the tunable-frequency qubit device on a distinct qubit drive control line to activate a single-qubit quantum logic gate. In certain instances, control signals, such as flux modulation signal and qubit drive signal, may be communicated to a qubit device on a common control line which is inductively and capacitively coupled to the qubit device. Control signals (e.g., a flux bias signal, a flux modulation signal, a qubit drive signal or another type of control signal) can be characterized by control parameters of the control signals including modulation parameters such as a DC flux bias Φ_{dc}, a flux modulation amplitude Pac, a flux modulation frequency fₘ, a modulation phase θₘ, and drive parameters, such as a drive amplitude Od, a drive frequency f_{d}, and a drive phase θ_{d}. In certain examples, the device parameters obtained from the device measurement process can be used to determine initial values of the control parameters of the control signals that can be applied to the respective quantum circuit devices, e.g., to activate a coupling between two qubit devices by tuning the coupler flux bias from a parking value to a gate-activating value, to deactivate a coupling between two qubit devices by tuning the coupler flux bias from a gate-activating value to a parking value, to bring two qubit devices into resonance for a precise time period, to activate a dissipative coupler device, and to perform other functions.

To perform the calibration, the control system of the example quantum computing system generates calibration signals, and the calibration signals are delivered to the quantum processing unit of the quantum computing system. The calibration signals can include, for example, microwave pulses applied to individual circuit devices (e.g., qubit devices), flux bias signals applied to individual coupler devices (e.g., tunable-frequency coupler devices), or other types of signals. The control system then obtains calibration measurements from the quantum processing unit, and the control system uses the calibration measurements to determine the control parameters. The predefined calibration routine can include, for example, the types of experiments, measurements, processes, optimization criteria or other features described in U.S. Pat. No. 10,282,675 entitled “Performing a Calibration Process in a Quantum Computing System;” other types of calibration routines may be used in some cases. During the calibration process, the control system obtains calibration measurement results from the quantum processing unit and uses the calibration measurements in the calibration routine, for instance, to identify an improved or optimal value of one or more control parameters. The calibration measurements may include readout signals from resonator devices or other types of measurements obtained from the quantum processing unit 104A. The control parameters that are modified based on the calibration measurements can include, for example, the amplitude (power), frequency, duration, or phase of a microwave pulse; the amplitude (power), frequency, duration, or phase of a flux bias signal; or other types of control parameters for control signals.

In some implementations, calibration signals are generated according to values of the control parameters (e.g., the initial values of the control parameters determined based on the device parameters or the improved values determined during the calibration process) and delivered to respective quantum circuit devices of the quantum processing unit (e.g., the qubit devices and the dissipative coupler devices where parametric dissipation operations are executed, or the qubit devices and non-dissipative coupler devices where a parametric quantum logic gate is executed). In order to perform a calibration measurement, calibration signals are communicated to respective quantum circuit devices to perform operations on the respective quantum circuit devices, e.g., tuning the effective coupling strength between two qubit devices, tuning the transition frequency of a tunable-frequency qubit devices, tuning the dissipation factor of dissipative coupler devices, and other operations.

In some cases, the calibration process (e.g., the dissipation calibration process and gate calibration process) may include a continuous-wave (CW) characterization procedure, which may include cavity spectroscopy measurements, qubit spectroscopy measurements, T1 and T2 measurements, and others. In some cases, the calibration process can include a pulsed characterization procedure, which may include cavity spectroscopy measurements, Rabi spectroscopy measurements, Ramsey spectroscopy measurements, power Rabi measurements, T1 and T2 measurements, and others. The CW or pulsed characterization procedures may perform measurements to detect the quality factor, resonance frequency, Lamb shift and other parameters of a device.

In some cases, the calibration process performed includes a gate tune-up procedure. For example, the gate tune-up procedure may include optimization of readout pulses or parameters, AC Stark coefficient measurements, pi-pulse amplitude tune-ups, Derivative Removal by Adiabatic Gate (DRAG) tune-ups, randomized benchmarking, other types of benchmarking, and others. The gate tune-up may include measurement of coupling strengths between qubit devices, characterization of tuning pulses for tunable-frequency qubit devices, and other types of measurements. In some cases, the calibration process includes a tune-up of multi-qubit quantum logic gates, single-qubit quantum logic gates, benchmarking procedures, or other types of processes.

In some cases, the calibration process may include a tune-up procedure for parametrically activated two-qubit quantum logic gates. The parametrically activated two-qubit quantum logic gate can be a quantum logic gate applied to a pair of qubits, where at least one of the qubits is defined on a tunable-frequency qubit device. The parametrically activated two-qubit gate can be performed by modulating the resonance frequency of the tunable-frequency qubit device. The tune-up procedure can include, for example, characterizing both qubits, calibrating the flux drive line transfer function, determining a good candidate resonance for coupling, determining an amplitude for flux modulation, performing a multi-dimensional modulated flux pulse measurement, optimizing over pulse parameters, and other types of operations.

In some implementations, the amplitude and other relevant control pulse characteristics are calibrated empirically. In particular, the XY control pulse used to manipulate the quantum state can be calibrated through a measurement of Rabi oscillations as a function of either the pulse amplitude given fixed pulse duration or vice versa. As the pulse amplitude is increased, the qubit will rotate further in the Bloch sphere. When the qubit is measured and the state vector of the qubit is projected onto the measurement axis, the resulting state visibility (probability of measuring the qubit in the excited state) will oscillate continuously between 0 and 1.

At 1014, the resulting sinusoid is fit to obtain the pulse parameters to obtain a pi rotation (Xₚᵢ gate) and use this to compute the driveability according to Eq. 33, 34. Note this measurement can be done where the same qubit device is measured, but signals are applied to different control line ports to determine the coupling strength between any drive line and the qubit. First the qubit frequency is determined as a function of applied flux bias. The driveability as a function of qubit frequency is then determined through Rabi oscillation measurements. In the final pane, driveability is shown for various qubits on a device across their tunable frequency range, and the median value is extracted for each qubit across this range, D_{median}∝X_{qd}. FIG. 11A is a plot 1100 showing the qubit rotation in Bloch Sphere in radius as a function of applied voltage in V. In some instances, the driveability can be computed by fitting a sinusoidal curve to the data obtained during suboperation 1012 (rotation angle as a function of applied voltage to the control line port) and using the radio-frequency pulse duration and voltage corresponding to a rotation angle in equations [35] and [36].

At 1016, a time-averaged relaxation rate (Γ₁) is determined. In some instances, Γ₁ can be measured many times over a time period (e.g., minutes, hours, or another time period) to get a sense of the time-averaged Γ₁. FIG. 11B includes an example of such a measurement of Γ₁, with a plot showing inferred excited state population and residuals of a qubit device as a function of decay time in microsecond (μs). In some instances, the calibrated pulse obtained during suboperation 1014 can be used to excite the qubit into the excited state. The excited state population (projection of the qubit state onto the measurement axis) is measured as a function of delay time between this excitation pulse and the measurement. By fitting the excited state population at several delay times to an exponential decay function, the decay, or loss, rate can be estimated. The loss rate corresponds to the exponential decay constant of the fitted curve (FIG. 11B).

At 1004, a Purcell limited relaxation rate (Γ_{1Purcell,CL}) is determined. In some implementation, the measured data is binned according to the computed Γ_{1Purcell,CL} value from the driveability (Equation 40) and the minimum/1 value measured in each bin can be extracted.

At 1006, an optimum value of the driveability considering the tradeoff between relaxation rate and gate performance is determined. In response to the minimum values of measured decoherence rate (Γ_{1 measured}) being correlated with the Purcell limited relaxation rate Γ_{1Purcell,CL}, fit relationship between min (Γ_{measured}) and the parameters varied. Extrapolate/interpolate as needed to select the desired tradeoff between coherence and driveability. In response to the minimum values of measured decoherence rate (Γ_{1measured}) being not correlated with the Purcell limited relaxation rate Γ_{1Purcell,CL}, The control line in question is not limiting Γ₁ over the range in question. Any driveability within the range measured can be selected without impacting coherence.

Using tunable-frequency qubit devices, Rabi oscillations as a function of qubit frequency can be measured, flux tuning the tunable-frequency qubit device over half of a flux period so as to sample over the widest range of frequencies possible. The period of the aforementioned standing wave is roughly 120-160 MHz. As most qubits used in these experiments have tunable ranges of 300-500 MHZ0 many periods of the standing wave are sampled. Frequencies for which a strongly coupled TLS is present (identified from deviations in the qubit frequency relative to what is expected from a transmon model fit to the entire dataset) can be then filtered out. These strongly coupled TLS tend to have a large impact on driveability. In some implementations, the median value of the driveabilty on the filtered dataset can be computed. The qubit Γ₁ can averaged and plotted over multiple measurements to account for temporal fluctuations and sampling noise as a function of driveability at every frequency over which these were measured and for all qubits in the various design splits that were tested. No correlation between the median or maximum Γ₁ and driveability is observed because indeed, this will be influenced by other factors such as TLS. However, the minimum value of the decoherence rate Γ₁ (e.g., the limit on Γ₁ in the absence of these other factors) shows strong correlation with fD², as expected according to the theory. In some instances, a predictive model between driveability (for a given qubit frequency) and the Purcell limit on relaxation rate can be obtained at least for a given configuration of a cryogenic fridge. In some implementations, the methods and systems described here facilitate mapping between fridge configurations by comparing the driveability measured on the same qubit device and the associated control line.

In certain examples, the methods and systems described here allow tuning of the control line-qubit device couplings through a combination of simulation and empirical calibration, both in terms of the coupling strength for optimal device operation (set by a target driveability D) and the Purcell limited Γ₁ obtained in practice. The methods and systems described here offer a powerful tool in understanding the performance of the device as fabricated and in-situ; and a versatile and systematic process for tuning and calibrating parameters.

FIG. 12A is a plot 1200 showing distributions for the median measured values of driveability (approximately 20-24 data points per box here, where a data point consists of the median measured values of driveability for a qubit device across its qubit frequency range) as a function of the arm rotation angle of the capacitive tuning element 530 shown in FIGS. 5A-5B. The simulated behavior is confirmed by the experimental data. In other words, the coupling strength between the control line 512 and the qubit device 514 decreases as the arm rotation angle of the capacitive tuning element 530 increases. The dotted line 1204 corresponds to a driveability at which a 60 ns single-qubit gate, or pi pulse rotation of a qubit, can be achieved on the architecture used in this example. The dotted line 1202 corresponds to a driveability at which a 20 ns single-qubit gate, or pi pulse rotation of a qubit, can be achieved on the architecture used in this example. For this particular example, this was the acceptable range of gate times targeted.

FIG. 12B is a plot 1220 showing Γ₁, fD² (lower limit) and f³D² (upper limit) as a function of the tunable frequency range of a qubit device. Note the peak in Γ₁ at around 4200 MHz, corresponding to a moderately coupled TLS, and the sudden increase in Γ₁ near the maximum frequency of the qubit. The latter is observed frequently and remains unexplained. Note also the correlation with both fD² (lower limit, curve 1222) and f³D² (upper limit, curve 1224), suggesting that the performance is Purcell limited by the drive line connected to the qubit. Coherence and driveability data across the frequency range of a tunable-frequency qubit device. fD² is the behavior of the Purcell limited coherence in the limit when the inductance of the control to ground does not contribute and f³D² is the behavior in the limit when loss through this inductor dominates the behavior.

FIG. 12C is a plot 1240 showing median value of the decoherence rate Γ₁ (over five measurements) as a function of fD² for all qubit devices measured across their tunable frequency ranges (90 frequency points were measured for each qubit, not all of which yielded a valid Γ₁ or D value). The plot looks almost identical when plotting over the upper limit of f³D² due to the minimal impact of the frequency change from 3.5 to 5 GHz. The minimum Γ₁, i.e., the limit on Γ₁ in the absence of these other factors, shows strong correlation with fD², resulting in the conclusion that this minimum is the Purcell limited Γ₁ set by the control line(s) coupled to the qubit device. Four devices were measured, and the Purcell limit appears to be relatively consistent across them. As shown in FIG. 12C, point 1242 represents an optimal point for spurious control line (prefer to minimize driveability, maximize coherence); point 1244 represents an optimal point for fast single-qubit gates (maximum driveability); and point 1246 represents an optimal point for qubit devices in question (fastest gates meeting coherence requirements). Line 1248 represents the best fit between measured coherence and expected Purcell limited coherence from this control line.

FIG. 13A includes schematic diagrams of top view and cross-sectional view of an example quantum processing unit 1300. The example quantum processing unit 1300 is a superconducting quantum processing unit includes two quantum processor wafers, e.g., a device wafer 1302 and a cap wafer 1304. As shown in FIG. 13A, the cap wafer 1304 includes a first surface 1306 and a second surface 208; and the device wafer 202 includes a first surface 1322 and a second surface 1323. The first surface 1306 of the cap wafer 1304 and the first surface 1322 of the device wafer 1302 face each other and are bonded together, for example spaced apart through bonding bumps.

The device wafer 1302 includes a quantum circuit device 1312 residing on the first surface 1322. The cap wafer 1304 includes a control line 1320 associated with the quantum circuit device 1312 and configured to communicate control signals to the quantum circuit device 1312 on the device wafer 1302. The control lines 1320 includes first and second control ports 1322A, 1322B, a circuit loop 1324, and conductive traces 1326 galvanically connected to the circuit loop 1324. In some implementations, the first and second control ports 1322A, 1322B includes superconducting through-hole vias extending from the first surface 1306 to the second surface 1308 of the cap wafer 1304. In some instances, the control line 1320 on the cap wafer 1304 may inductively and/or capacitively interact with the quantum circuit device 1312 on the device wafer 1302. In some instances, one control port of the control line 1320 may be galvanically connected to ground on the cap wafer 1304. In some instances, the device wafer 1302 and the cap wafer 1304 include ground planes on the first surface 1322 of the device wafer 202 and the first surface 1306 of the cap wafer 1304; and the ground planes on the device wafer 1302 and the cap wafer 1304 may be bonded together, for example, by the bonding bumps.

In some implementations, the example quantum processing unit 1300 may include additional and different features or components; and components of the example quantum processing unit 1300 may be implemented in another manner. For example, the features and components represented in FIG. 13A can be extended in a larger two-dimensional or three-dimensional array of devices. For another example, the example quantum processing unit 1300 may include respective readout resonator devices associated with the quantum circuit device 1312 for performing readout operations; and bonding bumps, through-hole conductive via, and multiple control lines (e.g., flux bias control lines and/or XY qubit control lines) for communicating control signals from a control system (e.g., the signal hardware 104A, 104B of the control system 105A, 105B) to the associated quantum circuit devices to perform quantum logic operations.

In some implementations, the quantum circuit device 1312 disposed on the first surface 1322 of the device wafer 1302 may be a tunable-frequency qubit device, a tunable-frequency coupler device, or another type of superconducting quantum circuit device. As shown in FIG. 13A, the quantum circuit device 1312 is configured as a tunable transmon qubit device with a pair of qubit electrodes 1314A, 1314B and two Josephson junctions forming a SQUID loop 1316. The pair of qubit electrodes 1314A, 1314B are configured to form a shunt capacitor in parallel with the SQUID loop 1316. In some instances, the qubit electrodes 1314A, 1314B of the quantum circuit device 212 may be configured to capacitively couple to other circuit components in the cap wafer 1304 or the device wafer 1302, for example, the conductive traces 1326 and the circuit loop 1324 of the control line 1320 on the cap wafer 1304. The SQUID loop 1316 and the qubit electrodes 1314A, 1314B include superconducting materials which may be surrounded by the ground planes on the first surface 1322 of the device wafer 1302. In some instances, the quantum circuit device 1312 may include additional or different features; and may operate as described with respect to FIG. 13A or in another manner. For example, the SQUID loop 1316 may include more than two Josephson junctions. As shown in FIG. 13A, the qubit electrodes 1314A, 1314B are electrically floating at a certain potential without being galvanically connected to the ground plane. In other words, since the ground plane is configured around superconducting quantum circuit device 1312, the qubit electrodes 1314A, 1314B are capacitively coupled to the ground plane.

In some implementations, the control line 1320 on the first surface 1306 of the cap wafer 1304 are made of superconductive material or other conductive material that carries a control signal to and from the quantum circuit device 1312 or other quantum circuit devices on the device wafer 1302. In some instances, the control line 1320 is a planar transmission line (e.g., coplanar waveguides, substrate integrated waveguides, or another type of planar transmission line).

In some examples, the control line 1320 is a flux bias line, a combined flux bias and qubit drive line, or another type of control line for communicating other types of control signals. In this case, the circuit loop 1324 is inductively coupled to the SQUID loop 1316, the frequency of the quantum circuit device 1312 can be tuned by applying a magnetic field through the SQUID loop 1316. The magnetic field can be generated by the flux bias line. The desired mutual inductance can be achieved by adjusting the distance between the circuit loop 1324 and the superconducting circuit loop 1316. In some cases, the distance between the circuit loop 1324 and the SQUID loop 1316 is defined by the distance between the two first surfaces 1306, 1322.

In some examples, the control line 1320 is a microwave line. In this case, the control line 1320 may be coupled to the quantum circuit device 1312 on the device wafer 1302 capacitively through the qubit electrodes 1314A, 1314B and inductively through the SQUID loop 1316. The capacitive coupling and the inductive coupling between the quantum circuit device 1312 and the control line 1320 can be set by the relative positions and distance of the cap wafer 1304 and the device wafer 1302. The state of the quantum circuit device 1312 can be manipulated by sending microwave pulses along the control line 1320.

In some instances, the control line 1320 which is capacitively and inductively coupled to the quantum circuit device 1312 is a combined flux bias and qubit drive line. In this case, the control signal on the control line 1320 can include a low-frequency component (e.g., typically with a highest frequency value up to ˜500 MHz or a different value) and a high-frequency component at or near the qubit frequency (e.g., typically about 4 GHz or a different value). The low-frequency component in the circuit loop 1324 generates a local magnetic field that interacts with the SQUID loop 1316 of the quantum circuit device 1312 and tunes the frequency of the quantum circuit device 1312. In this case, the low-frequency component of the current bias is a flux bias signal. The high-frequency component interacts capacitively with the qubit electrodes 1314A, 1314B of the quantum circuit device 1312 and causes the wavefunction in the qubit to change in a controlled fashion. The high-frequency component of the current bias is a microwave drive signal.

In some implementations, design parameters of the conductive traces 1326 are tuned, modified, and determined by modifying a differential capacitance between the control line 1320 and each of the qubit electrodes 1314A, 1314B. Each conductive trace 1326 includes a first section 1322 that extends in a first direction from a control port 1322A or 1322B toward the circuit loop 1324; a second section 1334 that extends in a second direction from the control loop 1324 toward one of the two qubit electrodes 1314B, wherein the second direction is perpendicular to the first direction; and an intermediate section 1336 that connects the first and second sections 1332, 1334. As shown in FIG. 13A, the qubit electrodes 1314A, 1314B are aligned along the first section 1332 of the conductive traces 1326 and are mirror images of each other relative to the central point of the first section 1332 of the conductive traces 1326. As shown in FIG. 13A, the circuit loop 1324 of the control line 1320 and the SQUID loop 1316 of the qubit device 1312 are arranged along the Z axis concentrically. In some instances, the design parameters of the control line 1320 include geometries of the conductive traces 1326. For example, tuning the differential capacitance can be performed by modifying a length of the second sections 1334, the angle and number of turns in the intermediate section 1336, locations of the control ports 1322A,1322B relative to the qubit electrodes 1314A, 1314B. It is noted that the arrangement of the control ports 1322A/1322B, conductive traces 1326, circuit loop 1324, the qubit electrodes 1314A/1314B, and the SQUID loop 1316 may have different shape, geometries; and may be arranged differently relative to another in another manner. In some instances, second sections 1334 of the conductive traces 1326 connected to the respective control ports 1322A, 1322B may extend toward different qubit electrodes. In some instances, the control line 1320 may not be symmetric along the A-A′ direction. For example, intermediate sections 1336 of the conductive traces 1326 connected to the respective control ports 1322A, 1322B may have different number of turns or different turn angles. For another example, first sections 1332 of the conductive traces 1326 connected to the respective control ports 1322A, 1322B may have different lengths. In some instances, tuning the properties of the control line 1320 may include tuning the geometry of the circuit loop 1324, and material properties of the control line 1320.

In some implementations, design parameters of the conductive traces 1326, such as location, size, shape, etc. of the different sections 1332, 1334, 1336, are configured to obtain a balanced gate performance (e.g., a fast gate time and a long Purcell limited decoherence time) according to predefined constraints. For example, geometric dimensions, positions, shapes, and other properties of the conductive traces 1326 can affect the coupling strength between the control line 1320 and the quantum circuit device 1312 by asymmetrically affecting the capacitance between the control line 1320 and each of the two qubit electrodes 1314A, 1314B.

In some implementations, initial design parameters of the one or more conductive traces 1326 of the control line 1320 are determined by performing a numerical simulation (e.g., full-wave electromagnetic simulation, quasi-electrostatic simulation, and other simulation); and may be further revised or modified according to an empirical measurement of driveability of the quantum circuit device 1312 through the control line 1320 in an actual setup (e.g., the control system, the signal delivery system, the cryostat, etc.). In some instances, the operations to determine the design parameters for the conductive traces 1326 of a control line 1320 can be performed according to the operations in the example process 400, 1000 in FIGS. 4, 10, or in another manner.

In certain instances, each of the device wafer 1302 and the cap wafer 1304 may include a substrate which may be an elemental semiconductor, for example silicon (Si), germanium (Ge), selenium (Se), tellurium (Te), or another elemental semiconductor. In some instances, the substrate may also include a compound semiconductor such as aluminum oxide (sapphire), silicon carbide (SiC), gallium arsenic (GaAs), indium arsenide (InAs), indium phosphide (InP), silicon germanium (SiGe), silicon germanium carbide (SiGeC), gallium arsenic phosphide (GaAsP), gallium indium phosphide (GaInP), or another compound semiconductor. In some instances, the substrate may also include a superlattice with elemental or compound semiconductor layers. In certain instances, the substrate includes an epitaxial layer. In some examples, the substrate may have an epitaxial layer overlying a bulk semiconductor or may include a semiconductor-on-insulator (SOI) structure.

In some implementations, the qubit electrodes 1314A, 1314B on the device wafer 1302, the control line 1320 on the cap wafer 1304, and the ground plane on the device and cap wafer 1302, 1304 include superconductive materials and can be formed by patterning one or more superconductive (e.g., superconducting metal) layers or other materials on the surface of the substrate. In some implementations, each of the one or more superconductive layers include a superconducting metal, such as aluminum (Al), niobium (Nb), tantalum (Ta), titanium (Ti), vanadium (V), tungsten (W), zirconium (Zr), or another superconducting metal. In some implementations, each of the one or more superconductive layers may include a superconducting metal alloy, such as molybdenum-rhenium (Mo/Re), niobium-tin (Nb/Sn), or another superconducting metal alloy. In some implementations, each of the superconductive layers may include a superconducting compound material, including superconducting metal nitrides and superconducting metal oxides, such as titanium-nitride (TiN), niobium-nitride (NbN), zirconium-nitride (ZrN), hafnium-nitride (HfN), vanadium-nitride (VN), tantalum-nitride (TaN), molybdenum-nitride (MoN), yttrium barium copper oxide (Y—Ba—Cu—O), or another superconducting compound material. In some instances, the qubit electrodes 1314A, 1314B and the ground plane may include multilayer superconductor-insulator heterostructures.

In some implementations, the qubit electrodes 1314A, 1314B, the control lines 1320, the quantum circuit device 1312, and the ground plane are fabricated on the top surfaces of the respective substrates and patterned using a microfabrication process or in another manner. For example, the qubit electrodes 1314A, 1314B, the control lines 1320, the quantum circuit device 1312, and the ground plane may be formed by performing at least some of the following fabrication steps: using chemical vapor deposition (CVD), physical vapor deposition (PVD), atomic layer deposition (ALD), spin-on coating, and/or other suitable techniques to deposit respective superconducting layers on the substrate; and performing one or more patterning processes (e.g., a lithography process, a dry/wet etching process, a soft/hard baking process, a cleaning process, etc.) to form openings in the respective superconducting layers.

FIG. 13B is a schematic diagram of a top view of an example superconducting quantum processing unit 1340. The example superconducting quantum processing unit 1340 includes superconducting circuitry with quantum circuit devices. As shown in FIG. 13B, the quantum circuit devices in the example superconducting quantum processing unit 1340 include tunable-frequency qubit devices 1342A, 1342B, 1342C, 1342D communicably coupled to a tunable-frequency qubit device 1342E through respective tunable-frequency coupler devices 1344A, 1344B, 1344C, 1344D. Each of the tunable-frequency qubit devices 1342A, 1342B, 1342C, 1342D, 1342E and each of the tunable-frequency coupler devices 1344A, 1344B, 1344C, 1344D may be implemented as the quantum circuit devices 1312 in FIG. 13A.

In some examples, the tunable-frequency qubit devices 1342A, 1342B, 1342C, 1342D, 1342E and the tunable-frequency coupler devices 1344A, 1344B, 1344C, 1344D may be implemented by other types of systems, and the features and components represented in FIG. 13B can be extended in a larger two-dimensional or three-dimensional array of devices. For example, each of the tunable-frequency qubit devices 1342A, 1342B, 1342C, 1342D may be further coupled to a distinct tunable-frequency qubit device through a distinct tunable-frequency coupler device. In some implementations, the example superconducting quantum processing unit 1340 represents a 5-qubit system in a device array with a square lattice. The example superconducting quantum processing unit 1340 may include additional or different features and components, which may be configured in another manner. For example, the quantum processing unit 1340 may include respective readout resonator devices associated with the tunable-frequency qubit devices 1342A, 1342B, 1342C, 1342D, 1342E for performing readout operations.

As shown in FIG. 13B, each of the tunable-frequency qubit devices 1342A, 1342B, 1342C, 1342D, 1342E and the tunable-frequency coupler devices 1344A, 1344B, 1344C, 1344D includes a pair of qubit electrodes. Each pair of qubit electrodes is electrically floating at a certain potential without being conductively connected to a ground plane. In other words, the qubit electrodes are capacitively coupled to the ground plane. In this case, each of the tunable-frequency qubit devices 1342A, 1342B, 1342C, 1342D, 1342E and the tunable-frequency coupler devices 1344A, 1344B, 1344C, 1344D is floating.

As shown in FIG. 13B, the example superconducting quantum processing unit 1340 includes control lines 1352, 1354 (e.g., flux bias control lines and/or XY qubit control lines) that a control system (e.g., the control system 105A,B shown in FIG. 1) uses for providing control signals to respective tunable-frequency qubit devices 1342 and respective tunable-frequency coupler devices 1344 (e.g., to activate or deactivate coupling between a pair of tunable-frequency qubit devices) and performing two-qubit quantum logic gates, or other types of quantum control operations. In particular, the quantum processing unit 1340 includes qubit control lines 1352A, 1352B, 1352C, 1352D, 1352E for respective tunable-frequency qubit devices 1342A, 1342B, 1342C, 1342D, 1342E; and coupler control lines 1354A, 1354B, 1354C, 1354D for respective tunable-frequency coupler devices 1344A, 1344B, 1344C, 1344D.

In some instances, each control line 1352, 1354 is inductively coupled to the respective SQUID loop of the respective quantum circuit device. In some instances, each control line 1352, 1354 may be also capacitively coupled to each of the two qubit electrodes from the same quantum circuit device. In certain instances, each of the two qubit electrodes may be also capacitively coupled to nearby control lines associated with neighboring quantum circuit devices, e.g., through parasitic capacitance. Design parameters (e.g., geometry, shape, location relative to the quantum circuit devices, etc.) of conductive traces of the control lines can be determined according to the operations in the example process 400, 1000 as shown in FIGS. 4, 10, or in another manner. In some instances, the design parameters of each control line are determined and optimized according to one or more predefined constraints considering balanced gate performance (e.g., fast gate time), long decoherence time, or other parameters.

Each of the tunable-frequency qubit devices 1342A, 1342B, 1342C, 1342D, 1342E and the tunable-frequency coupler devices 1344A, 1344B, 1344C, 1344D includes a SQUID loop that has two Josephson junctions connected in parallel. In some implementations, each of the SQUID loops can be inductively coupled to (has a mutual inductance with) a respective control line 1352, 1354, which can individually tune a magnetic flux in a respective SQUID loop. The control lines 1352, 1354 are connected to an external control system (e.g., the control system 105 in FIG. 1) which is configured to generate respective flux control signals. In some instances, the tunable-frequency qubit devices 1342A, 1342B, 1342C, 1342D, 1342E and the tunable-frequency coupler devices 1344A, 1344B, 1344C, 1344D may include additional or different features, and may operate as described with respect to FIG. 13B or in another manner. For example, each of the SQUID loops may include more than two Josephson junctions or may be configured in another manner.

The tunable-frequency qubit devices 1342A, 1342B, 1342C, 1342D, 1342E and the tunable-frequency coupler devices 1344A, 1344B, 1344C, 1344D shown in FIG. 13B resides on the top surface of a substrate 1360. In certain instances, the substrate 1360 may be implemented as the substrate 202, 250, 1302 in FIGS. 2A-2B, 13A. The superconducting circuitry of the superconducting quantum processing unit 1340 includes superconductive materials and can be formed by patterning one or more superconductive (e.g., superconducting metal) layers or other materials on the surface of the substrate 1360. The control lines 1352, 1354 may reside on a surface of a different substrate separated from the substrate 1360.

Some of the subject matter and operations described in this specification can be implemented in digital electronic circuitry, or in computer software, firmware, or hardware, including the structures disclosed in this specification and their structural equivalents, or in combinations of one or more of them. Some of the subject matter described in this specification can be implemented as one or more computer programs, i.e., one or more modules of computer program instructions, encoded on a computer storage medium for execution by, or to control the operation of, data-processing apparatus. A computer storage medium can be, or can be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or be included in, one or more separate physical components or media.

Some of the operations described in this specification can be implemented as operations performed by a data processing apparatus on data stored on one or more computer-readable storage devices or received from other sources.

The term “data-processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program, or in multiple coordinated files (e.g., files that store one or more modules, sub programs, or portions of code). A computer program can be deployed to be executed on one computer or on multiple computers that are located at one site or distributed across multiple sites and interconnected by a communication network.

Some of the processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application specific integrated circuit).

In a general aspect, tuning coupling strength between a qubit device and nearby control lines is described.

In a first example, a method includes identifying a design of first and second quantum processor wafers of a quantum processing system. The first quantum processor wafer includes a qubit device. The qubit device includes two qubit electrodes and a superconducting quantum interference device (SQUID) loop connected between the two qubit electrodes. The second quantum processor wafer includes a control line configured to apply control signals to the qubit device. The control line includes first and second control ports; a circuit loop inductively coupled to the SQUID loop; and conductive traces galvanically connected between the circuit loop and the respective first and second control ports, the control lines being capacitively coupled to the two qubit electrodes. The method further includes obtaining simulation data from numerical simulations of the quantum processing system based on the design; obtaining experimental data from measurements of the quantum processing system manufactured according to the design; and modifying the design of the second quantum processor wafer based on the simulation data and the experimental data. Modifying the design includes modifying a differential capacitance between the control line and the two qubit electrodes based on one or more predefined constraints.

Implementations of the first example may include one or more of the following features. The one or more predefined constraints include at least one of a minimum coherence time, a maximum gate time, or a minimum energy loss. Each of the first and second control ports includes a superconducting through-hole via extending from a first surface to a second opposite surface of the second quantum processor wafer.

Implementations of the first example may include one or more of the following features. Modifying the differential capacitance includes modifying a geometry of one or more of the control lines. Modifying the differential capacitance includes at least one of modifying a length of one or more of the control lines; and modifying an angle of one or more turns in one or more of the control lines. Modifying the differential capacitance includes at least one of adding one or more transmission line branches to one or more of the control lines on the second quantum processor wafer; and modifying one or more transmission line branches extending from one or more of the control lines of the second quantum processor wafer. Modifying the differential capacitance includes at least one of adding one or more transmission line branches to the qubit device on the first quantum processor wafer; and modifying one or more transmission line branches extending from the qubit device of the first quantum processor wafer.

Implementations of the first example may include one or more of the following features. The differential capacitance is a first differential capacitance. The qubit device is a first qubit device. The first quantum processor wafer includes a second qubit device communicably coupled to the first qubit device. The second qubit device includes two respective qubit electrodes. Modifying the design includes modifying a second differential capacitance between the control line and one of the two respective qubit electrodes of the second qubit device.

In a second example, a computing system configured to perform operations in the first example is described.

In a third example, a quantum processing system includes a first quantum processor wafer and a second quantum processor wafer. The first quantum processor wafer includes a qubit device. The qubit device includes two qubit electrodes and a SQUID loop connected between the two qubit electrodes. The second quantum processor wafer is bonded to the first quantum processor wafer. The second quantum processor wafer includes a control line configured to apply control signals to the qubit device. The control line includes first and second control ports; a circuit loop, and first and second conductive traces. The circuit loop is located between the first and second control ports and is inductively coupled to the SQUID loop. The first and second conductive traces are galvanically connected between the circuit loop and the respective first and second control ports, and is capacitively coupled to the two qubit electrodes.

Implementations of the third example may include one or more of the following features. The first and second conductive traces each includes: a first section that extends in a first direction from a control port toward the circuit loop; a second section that extends in a second direction from the control loop toward one of the two qubit electrodes, wherein the second direction is perpendicular to the first direction; and an intermediate section that connects the first and second sections. The qubit device is a floating qubit device, and the two qubit electrodes are capacitively coupled to a ground plane.

Implementations of the third example may include one or more of the following features. The control line includes one or more transmission line branches galvanically connected to the first conductive trace. The one or more transmission line branches extend from the first conductive trace toward at least one of the two qubit electrodes. The control line is configured to communicate control signals to the qubit device from a control system. Each of the first and second control ports includes a superconducting through-hole via extending from a first surface to a second opposite surface of the second quantum processor wafer. The qubit device is a first qubit device. The first quantum processor wafer includes a second qubit device comprises two respective qubit electrodes. The control line includes one or more transmission line branches galvanically connected to the first control port. The one or more transmission line branches extend from the first control port toward at least one of the two respective qubit electrodes of the second qubit device.

In a fourth example, a method of assembling a quantum processing system includes providing a first quantum processor wafer which includes a qubit device, where the qubit device includes two qubit electrodes and a SQUID loop connected between the two qubit electrodes; providing a second quantum processor wafer which includes a control line configured to apply control signals to the qubit device, where the control line includes first and second control ports; a circuit loop located between the first and second control ports; and first and second conductive traces galvanically connected between the circuit loop and the respective first and second control ports; and bonding the first quantum processor wafer and the second quantum processor wafer such that the circuit loop being inductively coupled to the SQUID loop and the first and second conductive traces being capacitively coupled to the two qubit electrodes.

Implementations of the fourth example may include one or more of the following features. The first and second conductive traces each includes: a first section that extends in a first direction from a control port toward the circuit loop; a second section that extends in a second direction from the control loop toward one of the two qubit electrodes, wherein the second direction is perpendicular to the first direction; and an intermediate section that connects the first and second sections. The qubit device is a floating qubit device, and the two qubit electrodes are capacitively coupled to a ground plane.

Implementations of the fourth example may include one or more of the following features. The control line includes one or more transmission line branches galvanically connected to the first conductive trace. The one or more transmission line branches extend from the first conductive trace toward at least one of the two qubit electrodes. The control line is configured to communicate control signals to the qubit device from a control system. Each of the first and second control ports includes a superconducting through-hole via extending from a first surface to a second opposite surface of the second quantum processor wafer. The qubit device is a first qubit device. The first quantum processor wafer includes a second qubit device comprises two respective qubit electrodes. The control line includes one or more transmission line branches galvanically connected to the first control port. The one or more transmission line branches extend from the first control port toward at least one of the two respective qubit electrodes of the second qubit device.

While this specification contains many details, these should not be understood as limitations on the scope of what may be claimed, but rather as descriptions of features specific to particular examples. Certain features that are described in this specification or shown in the drawings in the context of separate implementations can also be combined. Conversely, various features that are described or shown in the context of a single implementation can also be implemented in multiple implementations separately or in any suitable sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single product or packaged into multiple products.

A number of embodiments have been described. Nevertheless, it will be understood that various modifications can be made. Accordingly, other embodiments are within the scope of the following claims.

1. A method comprising:
identifying a design of first and second quantum processor wafers of a quantum processing system, the first quantum processor wafer comprising a qubit device, the qubit device comprising two qubit electrodes and a SQUID loop connected between the two qubit electrodes, the second quantum processor wafer comprising a control line configured to apply control signals to the qubit device, the control line comprising:
first and second control ports;
a circuit loop inductively coupled to the SQUID loop; and
conductive traces connected between the circuit loop and the respective first and second control ports, the conductive traces being capacitively coupled to the two qubit electrodes;
obtaining simulation data from simulations of the quantum processing system based on the design;
obtaining experimental data from measurements of the quantum processing system manufactured according to the design; and
modifying the design of the second quantum processor wafer based on the simulation data and the experimental data, wherein modifying the design comprises modifying a differential capacitance between the control line and the two qubit electrodes based on one or more predefined constraints.

2. The method of claim 1, wherein the one or more predefined constraints comprise at least one of:
a coherence time,
a gate time, or
an energy loss.

3. The method of claim 1, wherein each of the first and second control ports comprises a superconducting through-hole via extending from a first surface to a second, opposite surface of the second quantum processor wafer.

4. The method of claim 1, wherein modifying the differential capacitance comprises modifying a geometry of one or more of the conductive traces.

5. The method of claim 1, wherein modifying the differential capacitance comprises at least one of:
modifying a length of one or more of the conductive traces; or modifying an angle of one or more turns in one or more of the conductive traces.

6. The method of claim 1, wherein:
each of the conductive traces comprises:
a first section that extends in a first direction from a control port toward the circuit loop;
a second section that extends in a second direction from the control loop toward one of the two qubit electrodes, wherein the second direction is perpendicular to the first direction; and
an intermediate section that connects the first and second sections; and
wherein modifying the differential capacitance comprises:
modifying lengths of one or more sections of the conductive traces; and
modifying an orientation of the intermediate sections relative to the first and second sections.

7. The method of claim 1, wherein modifying the differential capacitance comprises at least one of:
adding one or more transmission line branches to the control line of the second quantum processor wafer; or
modifying one or more transmission line branches extending from the control line of the second quantum processor wafer.

8. The method of claim 1, wherein modifying the differential capacitance comprises at least one of:
adding one or more transmission line branches to the qubit device on the first quantum processor wafer; or
modifying one or more transmission line branches extending from the qubit device of the first quantum processor wafer.

9. The method of claim 1, wherein the differential capacitance is a first differential capacitance, the qubit device is a first qubit device, the first quantum processor wafer comprises a second qubit device communicably coupled to the first qubit device, the second qubit device comprises two respective qubit electrodes, and modifying the design comprises modifying a second differential capacitance between the control line and one of the two respective qubit electrodes of the second qubit device.

10. The method of claim 1, wherein obtaining experimental data comprises:
determining a Purcell limited relaxation rate of the qubit device based on the simulation data and the measurements.

11. The method of claim 10, wherein determining the Purcell limited relaxation rate of the qubit device comprises:
determining drivability and decoherence time for a specific qubit frequency and control line design;
determining a minimum relaxation time; and
determining an update value of the drivability based on a predefined criterion.

12. The method of claim 11, wherein the predefined criterion comprises a tradeoff between relaxation rate and gate performance.

13. A computing system comprising:
one or more processors; and
memory storing instructions configured to perform operations when executed by the one or more processors, the operations comprising:
identifying a design of first and second quantum processor wafers of a quantum processing system, the first quantum processor wafer comprising a qubit device, the qubit device comprising two qubit electrodes and a superconducting quantum interference device (SQUID) loop connected between the two qubit electrodes, the second quantum processor wafer comprising a control line configured to apply control signals to the qubit device, the control line comprising:
first and second control ports;
a circuit loop inductively coupled to the SQUID loop; and
conductive traces connected between the circuit loop and the respective first and second control ports, the conductive traces control lines being capacitively coupled to the two qubit electrodes;
obtaining simulation data from numerical simulations of the quantum processing system based on the design;
obtaining experimental data based on measurements of the quantum processing system manufactured according to the design; and
modifying the design of the second quantum processor wafer based on the simulation data and the experimental data, wherein modifying the design comprises modifying a differential capacitance between the control line and the two qubit electrodes based on one or more predefined constraints.

14. The system of claim 13, wherein the one or more predefined constraints comprise at least one of:
a coherence time,
a gate time, or
an energy loss.

15. The system of claim 13, wherein each of the first and second control ports comprises a superconducting through-hole via extending from a first surface to a second opposite surface of the second quantum processor wafer.

16. The system of claim 13, wherein modifying the differential capacitance comprises modifying a geometry of one or more of the conductive traces.

17. The system of claim 13, wherein modifying the differential capacitance comprises at least one of:
modifying a length of one or more of the conductive traces; or
modifying an angle of one or more turns in one or more of the conductive traces.

18. The system of claim 13, wherein:
each of the conductive traces comprises:
a first section that extends in a first direction from a control port toward the circuit loop;
a second section that extends in a second direction from the control loop toward one of the two qubit electrodes, wherein the second direction is perpendicular to the first direction; and
an intermediate section that connects the first and second sections; and
wherein modifying the differential capacitance comprises:
modifying lengths of one or more sections of the conductive traces; and
modifying an orientation of the intermediate sections relative to the first and second sections.

19. The system of claim 13, wherein modifying the differential capacitance comprises at least one of:
adding one or more transmission line branches to one or more of the conductive traces; or
modifying one or more transmission line branches extending from one or more of the conductive traces.

20. The system of claim 13, wherein modifying the differential capacitance comprises at least one of:
adding one or more transmission line branches to the qubit device of the first quantum processor wafer; or
modifying one or more transmission line branches extending from the qubit device of the first quantum processor wafer.

21. The system of claim 13, wherein the differential capacitance is a first differential capacitance, the qubit device is a first qubit device, the first quantum processor wafer comprises a second qubit device communicably coupled to the first qubit device, the second qubit device comprises two respective qubit electrodes, and modifying the design comprises modifying a second differential capacitance between the control line and one of the two respective qubit electrodes of the second qubit device.

22. The system of claim 13, wherein obtaining experimental data comprises:
determining a Purcell limited relaxation rate of the qubit device based on the simulation data and the experimental data.

23. The system of claim 22, wherein determining the Purcell limited relaxation rate of the qubit device comprises:
determining drivability and decoherence time for a specific qubit frequency and control line design;
determining a minimum relaxation time; and
determining an update value of the drivability based on a predefined criterion.

24. The system of claim 23, wherein the predefined criterion comprises a tradeoff between relaxation rate and gate performance.

25-38. (canceled)
